(19) United States
(12) Patent Application Publication
(10) Pub. No.: US 2018/0322597 A1
(43) Pub. Date: Nov. 8, 2018

(54) DECENTRALIZED CRYPTOGRAPHIC REAL ESTATE TRANSACTION ASSISTANCE SYSTEM AND METHOD

(71) Applicant: Robert Sher, Chicago, IL (US)

(72) Inventor: Robert Sher, Chicago, IL (US)

(21) Appl. No.: 16/026,973

(22) Filed: Jul. 3, 2018

Related U.S. Application Data
(63) Continuation-in-part of application No. 15/692,645, filed on Aug. 31, 2017.
(60) Provisional application No. 62/381,670, filed on Aug. 31, 2016.

(51) Int. Cl. G06Q 50/16; G06Q 10/10; G06Q 20/38; G06Q 30/06; G06Q 50/00; H04L 29/08; G06Q 40/08

(52) U.S. Cl. CPC G06Q 50/163; G06Q 10/10; G06Q 20/3821; G06Q 40/08; G06Q 30/0645; G06Q 50/01; H04L 67/1074; G06Q 30/0609

(57) ABSTRACT

A decentralized cryptographic real estate transaction assistance system and method is provided to facilitate matching, engaging, contracting, and communicating between parties to a real estate and/or property rental transaction by a network-leveraged system. The decentralized cryptographic real estate transaction assistance system and method may include a property rental and real estate transaction assistance platform, database, platform components, renter component, matching component, communication component, broker-assisted component, landlord direct component, landlord management component, vendor portal, lead marketplace component, guaranteed rental income protection, renter profile validation aspect, and tenant exchange. A method for facilitating matching, engaging, contracting, and communicating between parties to a real estate and/or property rental transaction by a network-leveraged system using the decentralized cryptographic real estate transaction assistance system and method is also provided.

### CROSS-REFERENCE TO RELATED APPLICATION

This application claims the priority from U.S. nonprovisional patent application Ser. No. 15/692,645 filed Aug. 31, 2017 with the title NETWORK-LEVERAGED REAL ESTATE TRANSACTION ASSISTANCE SYSTEM AND METHOD, which claims priority from provisional patent application Ser. No. 62/381,670 filed Aug. 31, 2016. The foregoing applications are incorporated in their entirety herein by reference.

### FIELD OF THE INVENTION

The present disclosure relates to a decentralized cryptographic real estate transaction assistance system and method. More particularly, the disclosure relates to facilitating matching, engaging, contracting, and communicating between parties to a real estate and/or property rental transaction by a decentralized system. The present disclosure additionally relates to income protection, payment platforms, securitized rental transactions, and non-rental transactions.

### BACKGROUND AND TECHNICAL PROBLEMS

The traditional residential rental process is slow, inefficient, and lacks transparency, which can create a large time and cost burden on renters, landlords, and agents. No known reference provides a much-needed paradigm shift to upgrade practically all things real estate by simplifying the rental process for renters, landlords, and agents.

The current industry experiences renter-side problems. Renters often incur losses due to a flawed rental process calculated by the loss of time and money. Application fees cause the current rental searching process to be cumbersome, sometimes requiring renters to spend significant money on application fees while applying for units with multiple landlords.

Additionally, during the application process, renters are subjected to a FICO credit review. Often, this review occurs multiple times with multiple credit retrievals that damage the renter's FICO Score. Moreover, renters are judged by the same credit standard mortgage banks use to underwrite mortgage loans. The car industry uses a “FICO Auto Score”. The mortgage lending industry uses the standard FICO score. Furthermore, rent payment performance is not often reported to the credit bureaus. Many qualified renters with low FICO or other difficult past are often considered too high a risk to be qualified to rent, and many renters face a real threat of homelessness. No known practice considers actual renter risk and prevents good renters, regardless of their FICO, to being grouped with bad renters and left with few to no housing options. This harsh practice creates a problem of leaving renters with few housing options.

Furthermore, renters are generally forced to compete for apartments whenever those apartments become available and marketed on various websites. Competition is a major hurdle for renters. Even if there are three great candidates applying for the same apartment, there can only be one lease. This is highly inefficient, and renters have no organized data resource which would allow renters to apply for apartments in anticipation of an upcoming vacancy. There is no currently known way for renters who were not selected for a rental to reuse their application with a different landlord and avoid another application fee another credit check.

Renters generally must either use agents or online listing platforms. However, data is not shared across the platforms. If the renter uses an agent and then finds an apartment through a listing service or on their own, their information is stuck with the agent. Alternatively, if a renter applied with a landlord and the application did not result in a lease, the renter must start all over with another landlord or broker—often being forced to complete new paperwork, pay more application fees, have their credit score run again, and spend additional time, money, and/or energy restarting the same process somewhere else. There is currently no known way to avoid submitting their personal information to different landlords and brokers multiple times

Sometimes, listing data is inaccurate compared to what a landlord states on a website or over the phone. Landlords can give one renter one price, another renter a different price, and lease terms and cost to sign can vary greatly. If listing data is different from the info the landlord gives, this creates confusion which isn't easily rectified. Other than flagging an advertisement, there is no way for the renter community to update “true-up” listing info.

When a renter finally rents an apartment, unknown adverse conditions and challenges may become known, including bad neighbors, hidden issues in the building like mold, radon, bugs, rodents, or gang and drug activity. Mainstream online review outlets can't be trusted to uncover these issues. Many renter lease default situations cannot be avoided and cause(s) of such information is not organized, verified, nor trustworthy.

Furthermore, renters currently don't have an option to join an online “renter only” community where they can engage other renters and tenants in a social media setting. Additionally, there are no known renter-member platforms where renters can engage in commerce with other renter members and/or third parties to buy, sell, and trade goods and/or services. There are no known platforms to convert rental to sales using automation follow-up tasks and cultivate relationships and use rental experience to substantially automatically pre-qualify, qualify, approve, and underwrite renters for mortgage financing. Furthermore, renters currently do not have an option to join an online “renter only” community where they can engage other renters and tenants in a social media setting. Additionally, there are no known renter-member platforms where renters can engage in commerce with other renter members and/or third parties to buy, sell, trade goods and/or services, currencies, and one or more financial instruments.

The current industry experiences broker-side problems. Agents are busy people who spend a lot of time trying to market and sell to successfully earn money. Comparing rental and sales commissions, sales commission can be from $2,000 to $18,000+ per closing and is many times higher than a rental commission which can be from $250 to $1,500+ per closing. As result, most busy agents would rather pass-up a rental lead and focus on sales leads. Rental Agents who focus on residential leasing would often rather network and invest in marketing rather than do all the repetitive tasks of qualifying, matching to property, and showing apartments, as this work is a huge investment of time and money with very little return. For example, agents routinely lose time on application screening; gathering renter paperwork, forms, and verifications; organizing communication between calls, texts, and emails; matching renters to apartments; showing apartments; and/or completing and delivering a lease.

Agents also incur tremendous expenses during their regular course of business. Many rental agents waste money on MLS fees or a commission split with a cooperating agent. For example, a $1000 rental can easily turn into a $150 commission after the agent splits their commission with the cooperating agent; pays his/her broker split; and pays a myriad of other mandatory office, license, MLS, D&O insurance, association fees, closing and/or office fees. For most agents, the cost of working at a brokerage is hidden or unknown until closing their first deal. There is no known clear way of learning in advance what sort of compensation an agent will earn working for a brokerage. Moreover, some brokerages have a culture of poaching leads from agents, not paying commissions, reducing commission without warning, and not disclosing all costs payable to the brokerage when a deal closes. It is hard to find trustworthy reviews about brokerages.

Real property viewing expense can be an issue. To make money, an agent generally must perform leasing activities under pressure to close due to personal and operating costs, such as fuel spent on showings, car insurance, car maintenance, and car payments. While under pressure to meet financial obligations, some agents may give a landlord an application lacking adequate renter data to determine a renter's qualifications in hopes of closing the deal fast. Some agents will even withhold critical renter data and send an application to a landlord knowing the renter is not qualified to rent and/or has a high probability of default. Currently there is no known, simple, and affordable management tool available to an agent or brokerage to track worker accountability, performance, and track lease default history. Data flow and report generation between advertisers, landlord data procurement personnel, agent team members, and office staff is limited and lacks transactional transparency and sufficient and trustworthy historic data.

Some brokerages will give leads to agents. Some third-party companies offer to sell leads to agents. There is no known simple way for agents to sell, transfer, and/or track leads serviced by other agents. Additionally, if a lead is transferred within an agent's team or sold to other agents, the lack of lead process transparency can be a major hurdle which prevents the buy/sell/transfer of leads and inhibits the growth of team structures due to lack of trust. Lead tracking within a brokerage is possible with a strong process and lots of paperwork, messaging, and updates. However, once a lead is referred to agents outside of the brokerage, tracking is nearly impossible, and business is then transacted on an honor system. The lack of trusted leads tracking for referral compensation can lead to a “lone wolf syndrome”, which can cause most agents to work on their own, not share leads, not share information, and not work in teams. Agents simply lack a transparent process that will give agents assurance that their referred lead will get serviced, and that the referring/originating agent will get paid when the referred lead closes.

High producing teams, once built, are not currently monetizable. Real Estate companies can be bought and sold, but not agent teams created by agents, not by brokerages. Agent created teams are an investment not easily monetizable and currently not easily transacted by an agent that may want to buy, sell or transfer a team that produces income or controls assets.

An agent invests a lot of time and energy to consistently procure rental listings. Setting a listing appointment, driving to the listing appointment, spending two to three hours filling out the myriad of listing forms on paper, inputting the same information into the MLS, then the agent's community resource management (CRM), sending a copy of the listing to the broker, getting signature from the broker to then send signed copies to the landlord, then again more typing of the same information into online listings such as Craigslist, Zillow and other advertising websites. If a property listing does not exist in the MLS, the data input process can easily take half a day, even with the help of electronic document signing services because of the many forms and lengthy input procedure.

Once a unit is filled, there may be leftover applicants. For agents and landlords, organizing rental leads is also very complicated. Phone intake, emails, documents, forms, text messages, application and verification forms, questionnaires, and scheduling all takes a tremendous amount of time. Agents and landlords collect dozens of renter applications for each rental listing while a unit is on the market. After a landlord or agent fills the rental property, leftover renter applications are often discarded. No known platform exists to easily convert these leads into money, which an agent or landlord worked so hard to accumulate.

The industry currently lacks solutions for landlord-side problems. Even with tools such as FICO Scores, criminal and eviction reports, income verifications, rental verifications, and personal references, landlords can still get surprised with having to evict their tenant. This can in part be due to lack of data transparency. Despite the positive references, landlords may have an incomplete picture as to whether a renter will really pay rent. There is no known industry standardized system or process for rental payment reporting with the credit bureaus (Experian, Transunion, Equifax). Also, if a landlord wants to get rid of a tenant, a landlord can lie to a prospective future landlord of the tenant and claim rent payments were on-time. Other issues that lack transparency can include: how the renter behaved around his previous neighbors or whether the renter was polite to the maintenance people and landlord.

For a landlord, trying to find the right tenant consumes tremendous energy, involving numerous emails and phone calls, screening applications, verifying all the info received, and conducting real property showings and interviews. No known website or technology exists that gives landlords the option to hand-pick renters from a renter candidate list which compares and matches the landlord's criteria and/or requirements against the profiles of renter candidates. Renters have long been able to search through a listing website for apartments, however landlords have no such feature to find tenants, where a renter's or tenant's profile can be searched and reviewed before contacting that renter or tenant.

Presently, landlords find renters by publishing their apartment for rent. This publication usually happens once the landlord learns a current tenant is moving out. Currently, there is no option for renters to contact landlords with an offer to lease in advance of a scheduled lease expiration. Landlords cannot passively receive rental applications unless landlords advertise their apartments for rent. Landlords who've dealt with the cost of eviction understand the value of income protection. While some products may attempt to offset eviction costs, no known product exists that will protect the landlord's rental income.

If a tenant requests a service, the investigation and resolution process is complicated and time consuming. Landlords must investigate the maintenance issue, call their maintenance person, and confirm that maintenance was performed to the landlord's standards. This is time-consuming. Many landlords do not have established relationships with maintenance crew, vendors, and various supportive services, or cannot afford to keep their own full-time, on-demand maintenance crew. Finding qualified people to answer landlord's specific service needs, including but not limited to tenant service requests, is difficult. More importantly, there is no known system that integrates all these services with a landlord's property management and bookkeeping system.

Landlords have long kept track of revenue and expense by building. There is no known system that allow landlords to easily analyze and view revenue and expense reports by unit. Furthermore, landlords have no known simple and affordable system or method to substantially automatically track and report timeliness of renter payment, frequency and severity of maintenance issues, and other issues as components of a weighted renter/tenant score. Furthermore, renter-to-landlord, renter-to-renter, and renter-to-vendors interaction is not accounted for nor quantified and factored into a score for each participant. A process is needed to further define the quality of the renter and create transparency, efficiency, and fairness for each party to the transaction, exchange, and/or communication.

Therefore, a need exists to solve the deficiencies present in the prior art. What is needed is a system to modernize the traditionally slow and laborious process involved in a property rental transaction. What is needed is a system to analyze potential tenants using criteria of rules and match potential tenants with compatible landlords. What is needed is a system to determine a financial profile of a user using novel and effective criteria indicative of a likelihood of compliance with obligations of a transactional relationship. What is needed is a system and method to facilitate management of a property rental and/or real estate transaction for landlords, brokers, and other parties. What is needed is a system and method to manage substantially real-time landlord and real property listings and permitting continuing updates to same. What is needed is a network-leveraged and/or decentralized system to perform a preliminary analysis of prospective parties to a property rental and/or real estate transaction to quantify and measure continued interaction, such as viewing of a proposed unit subject to the lease or sale transaction and beyond. What is needed is a method for operating a network-leveraged system to facilitate a property rental and/or real estate transaction, to maintain continuing relationship between parties. What is needed is a decentralized system to realize these deficiencies.

### SUMMARY

An aspect of the disclosure advantageously provides a system to modernize the traditionally slow and laborious process involved in a property rental transaction. An aspect of the disclosure advantageously provides a system to analyze potential tenants using criteria of rules and match potential tenants with compatible landlords. An aspect of the disclosure advantageously provides a system to determine a financial profile of a user using novel and effective criteria indicative of a likelihood of compliance with obligations of a transactional relationship. An aspect of the disclosure advantageously provides a system and method to facilitate management of a property rental and/or real estate transaction for landlords, brokers, and other parties. An aspect of the disclosure advantageously provides a system and method to manage substantially real-time landlord and real property listings and permitting continuing updates to same. An aspect of the disclosure advantageously provides a network-leveraged system to perform a preliminary analysis of prospective parties to a property rental and/or real estate transaction to qualify and measure continued interaction, such as viewing of a proposed unit subject to the lease or sale transaction and beyond. An aspect of the disclosure advantageously provides a method for operating a network-leveraged and/or decentalized system to facilitate a property rental and/or real estate transaction, to maintain a continuing relationship between parties, which may include and use smart contracts. An aspect of this disclosure advantageously provides a method for a renter community to engage in an exchange or commerce of goods and/or services. An aspect of the disclosure advantageously provides a method and option for renters, landlords, agents, and third parties to create separate and/or subcommunities to engage as a renter/tenant only social media, peer-to-peer communication. An aspect of this disclosure provides a decentralized system to assist with these advantageous features.

Aspects of this disclosure may provide a new set of rules for the real estate market and/or real estate rental market upon which it will create a first ever renter score, a financial model to issue credit instruments, advertising, marketing platform, leads, lead conversion to renter, renter conversion to tenant, renter conversion to buyer, tenant conversion to buyer, and teams commerce platforms, renter multiple listing service (RMLS), bundle lease securities, guaranteed rental income protection (GRIP), dynamic virtual teams, management tools for landlords and brokers, process automation, substantial automation that may leverage VOIP and virtual services, rental process which is not dependent on the FICO, renter managed real-time landlord listing updates, automated listing services for agents and landlords, renter community where landlords, vendors, communities, and renters can pay rent and request maintenance in person or online, and renter/landlord/agent/vendor reviews and ratings. These features may be provided using a decentralized system, for example, a system using a distributed ledger and/or blockchain. A renter process may be provided that allows renters to navigate through a broker process and landlord process substantially faster, simpler, without sending multiple applications, sharable with landlords to view using a temporary token, and simultaneously, without needing multiple application fees or depending on a FICO score, to sign a lease in person, using a virtual property tour, using VR and/or 3D, and/or online, quickly and easily. A renter and landlord process where renters and landlords can upload proof of renter payment to build credibility and supportive documentation for renter and landlord, and for which a verification feature will create additional measures of confidence that the information provided by either or both the parties is true. Blockchain, multi-factor authentication, and/or other technologies may be used to ensure rent payment history is accurate, for example, not falsified.

Aspects of this disclosure may allow renters to use a broker or not, for example, a direct-to-landlord process. With landlord direct, a renter may use an automated web-based system to complete the entire rental process. If the renter prefers the guidance of a real estate agent, a broker-assisted process may provide the renter a mostly-automated web-based system to complete the entire rental process, and still enjoy the benefits of having an interaction with a real estate professional, including to obtain pre-approval from a landlord before seeing a unit so the renter does not have to waste time going to the unit if the landlord is not going to rent to that renter. These options may employ the latest software technology to provide automated on-boarding process options to quickly process and assist renter applicants through the entire rental experience including searching, applying, scheduling, viewing, reviewing, negotiating, lease signing, communicating, managing documents, screenings, substantially automatically being matched to property based on their profile, criteria, rating, preferences, and accounting for local and other laws and/or ordinances, continuing the use of the system throughout the duration of their tenancy, and exiting the lease. At least part of these technologies may be provided using a decentralized platform. Aspects of this disclosure may allow renters to pay rent online, join an online renter community, make maintenance requests, rate landlords, neighbors, vendors, products, services, and/or local businesses. Renters, brokers, agents, and other parties may use one or more of systems enabled by this disclosure to find landlords before a unit is advertised for rent.

In at least one aspect of this disclosure, traditional agents may be paid a commission based on a specified month rent amount, such as a first month, where a renter chooses to sign a lease. The renter may pay the specified month rent, and then some or all of the specified month rent funds may be sent by the landlord to the agent or broker office. In traditional operations this disclosure improves or solves, this type of transaction undesirably takes time for the agent to get paid and provides little incentive for traditional agents to find lower cost units for renters because the lower the rent, the lower the commission. Conversely, a system enabled by this disclosure advantageously assists agents to find a Lease Offer and renters may pay our agents their Rent Max as a Lease Offer/Service Fee. This improvement may maximize income for agents using a system enabled by this disclosure and may help associated agents avoid a conflict of interest that many traditional agents struggle with. A system enabled by this disclosure advantageously empowers agents to make a flat fee, earn favorable income on practically every transaction, not have to wait for a landlord to send payment to the agent, and assist agents to focus on finding the best opportunity for the renter which is often times under the renter's budget.

A system enabled by this disclosure advantageously assists agents to help landlords budget rent incentives, for renters to take the landlord's unit, by spreading rent discounts over the remaining months of the lease and keeping the new higher rent below the renter's max budget. If an agent can negotiate for the landlord to give the renter a discounted rate, for example a first month free, the agent may get a bonus. With these advantageous improvements provided by this disclosure, a considerable number of landlord lease offers, for example 80%, may include an incentive such as the first month rent free.

Furthermore, a service/lease offer fee collected by the agent, brokerage, and/or office may be used to find offers and if the renter chooses to stop service, the unused portion of the service fee may be refunded according to a refund schedule, if renter did not default on their agreement with the agent/brokerage/office. This may provide a process that is kinder to the agent and incentivize the agent to continuously search for offers and get paid for the work they accomplish. Converse to many other professionals that get paid regardless if they are successful or not in their endeavors, for example doctors or some attorneys, many traditional agents don't get paid if they succeed in meeting the renter's criteria. In at least one embodiment, a performance-based compensation package may be included to pay agents based on their successes, such as with a bonus or only if they meet the renter's criteria and/or other contractual obligations, without limitation.

Accordingly, the disclosure may feature a system for assisting a transaction including a database accessible via a network to store and communicate data relating to a transactional relationship and rules applied to the transactional relationship. The database may be decentralized. The system may include platform components communicably connected to the database to analyze and manipulate the data. The platform components may include a renter component to manage a renter profile including renter information and analyze at least part of the renter profile to derive a renter score for association with a renter. The renter score may be includable by the renter profile. The renter profile may be included by the database. The platform components may include a renter profile validation aspect to validate at least part of the renter information. The renter information determined not to be valid may be selectively excluded from the renter profile. The platform components may include a matching component to compare at least part of the renter profile and information indicative of renter behavior to the rules to determine whether a likelihood of compatibility with a landlord requirement relative to a real property unit meets a matching threshold. The matching component may match the renter and a landlord meeting the matching threshold. The platform components may include a token exchange aspect to coordinate sharing of at least part of the renter profile at least partially identifying the renter with the landlord. The renter may grant access to an authorization token for the landlord of the real property unit for consideration for the transactional relationship. The authorization token may be revocable. The platform component may include a communication component to facilitate interactions and organize the interactions. The interactions may be recordable to the database. An interface accessible to interact with the and at least one of the platform components may be included. At least part of the data may be analyzed to predict a behavior associated with the transactional relationship and/or parties to the transactional relationship. VOIP and/or API features may be included to leverage communication, analysis, and other services.

In another aspect, the platform components may be operable as a decentralized autonomous organization.

In another aspect, a smart contract component may be included to define at least part of the rules and execute an action of a smart contract upon compliance with a condition of the rules. The rules may include determining the likelihood of compatibility between the parties to the transactional relationship. Additional parameters and/or thresholds may include determining the likelihood of compatibility between the parties to the transactional relationship.

In another aspect, a broker-assisted component may be included to assist an agent with the transactional relationship. The broker-assisted component may include an agent-renter CRM aspect to at least partially automate tasks related to the transactional relationship using the smart contract, and a renter qualification aspect that may work with the matching component to substantially identify the renter with the likelihood of compatibility with the landlord for the real property unit in consideration for the transactional relationship. The broker-assisted component may help ensure compensation and expedite the rental process. Agents may charge fees upfront for agreed services before or after obtaining a rental offer from a landlord. A broker may use GRIP and an audio, video, and/or digital profile created to market or enhance a renter to increase likelihood of success that a landlord or property manager will accept the renter.

In another aspect, the database may be at least partially provided as a distributed ledger. The data added to the database may be added to the distributed ledger.

In another aspect, a guaranteed rental income protection may be provided to assure financial stability in the transactional relationship. The rules may include a threshold of eligibility for the guaranteed rental income protection. The guaranteed rental income protection may be selectively offered for the transactional relationship that meets the threshold of eligibility. The guaranteed rental income protection may be marketable as a financial instrument. GRIP may be used to spawn, leverage, and/or be used with insurance products for renters, landlords, and/or vendors. GRIP may use a monthly or other periodic premium, subscription, or other model to monetize and cover risk of issuing or offering GRIP. Additionally, GRIP may include limits, deductibles, and other stipulations, conditions, variables, or exceptions.

In another aspect, the database may be provided as a blockchain to store the data. The data being added or manipulated may be added as a block to the blockchain. Historical transactions associated with the data may be accessible from the blockchain.

In another aspect, a guaranteed rental income protection may be provided respective to the blockchain to assure financial stability in the transactional relationship. The rules may include a threshold of eligibility for the guaranteed rental income protection. The guaranteed rental income protection may be selectively offered for the transactional relationship that meets the threshold of eligibility. The guaranteed rental income protection may be reflective of at least part of the data stored in the blockchain. The guaranteed rental income protection may be stored in the blockchain.

In another aspect, the platform components may include a landlord direct component. The landlord direct component may include a renter search aspect to locate the renter prospective to engage in the transactional relationship. The renter may be filterable by the renter score. The landlord direct component may communicate with the matching component to connect the renter having the likelihood of compatibility that is acceptable with the landlord. The information relating to the renter having the likelihood of compatibility that is acceptable with the landlord may be storable in the database.

In another aspect, the landlord direct component may include a record keeping aspect to log at least part of the interactions between the parties. The at least part of the interactions may be storable in the database. The landlord direct component may include a renter community aspect to facilitate the interaction between at least the renter, additional renters, and the landlord, the interactions being storable in the database.

In another aspect, the platform components may include a landlord management component. The landlord management component may include a landlord financial aspect to receive payments from the renter. The landlord management component may include a maintenance request aspect to receive a maintenance request for the real property unit. The landlord management component may include a landlord-vendor management aspect to request service from a vendor, manage costs to the vendor, and log the interactions with the vendor. The landlord management component may include a tenant exchange to transact rights to a tenant of the transactional relationship. Additional renters, profiles, or search criteria may be filterable. Renter, landlord, property, unit, procedural, transactional, financial, personal, and other data may be stored in a database, such as included by a blockchain. The landlord management component may also include an aspect to reimburse a renter for expenses and/or to pay the renter for goods/services. The tenant exchange is discussed further in the detailed description of this disclosure.

According to an embodiment of this disclosure, a system for assisting a transaction is provided including at least a database and platform components. The database may be decentralized among a distributed ledger and accessible via a network to store and communicate data relating to a transactional relationship and rules applied to the transactional relationship. At least part of the platform components may be operable as a decentralized autonomous organization communicably connected to the database to analyze and manipulate the data. The platform components may include a renter component to manage a renter profile including renter information and analyze at least part of the renter profile to derive a renter score for association with a renter. The renter score may be includable by the renter profile. The renter profile may be included by the database. The platform components may include a matching component to compare at least part of the renter profile and information indicative of renter behavior to the rules to determine whether a likelihood of compatibility with a landlord requirement relative to a real property unit meets a matching threshold. The matching component may assist with matching the renter and a landlord for which the matching threshold is met. The platform components may include a token exchange aspect to coordinate sharing of at least part of the renter profile at least partially identifying the renter with the landlord. The renter may grant access to an authorization token for the landlord of the real property unit for consideration for the transactional relationship. The authorization token may be revocable. The platform components may include a smart contract component to define at least part of the rules and execute an action of a smart contract upon compliance with a condition of the rules. The platform components may include a communication component to facilitate interactions and organize the interactions, the interactions being recordable to the database. At least part of the data may be analyzed to predict a behavior associated with the transactional relationship and/or a party to the transactional relationship.

In another aspect, a renter profile validation aspect may be included to validate at least part of the renter information included by the renter profile. The renter information determined not to be valid may be selectively excluded from the renter profile. An interface accessible to interact with the data and at least one of the platform components may also be included.

In another aspect, a broker-assisted component may be included to assist an agent with the transactional relationship. The broker-assisted component may include an agent-renter CRM aspect to at least partially automate tasks related to the transactional relationship using the smart contract. The broker-assisted component may include a renter qualification aspect that may work with the matching component to substantially identify the renter with the likelihood of compatibility for the landlord for the real property unit in consideration for the transactional relationship.

In another aspect, a guaranteed rental income protection may be provided to assure financial stability in the transactional relationship. The rules may include a threshold of eligibility for the guaranteed rental income protection. The guaranteed rental income protection may be selectively offered for the transactional relationship that meets the threshold of eligibility. The guaranteed rental income protection may be reflective of at least part of the data stored in the distributed ledger. The guaranteed rental income protection may be stored in the distributed ledger. GRIP may be used to ensure rent income and rent payment managed by smart contracts and may be used to pay expenses and reduce cost of accounting, management, oversight, and/or income and expense preparation costs, for example, performed quarterly or annually.

In another aspect, the distributed ledger may be provided as a blockchain to store the data. The data being added or manipulated may be added as a block to the blockchain. Historical transactions associated with the data may be accessible from the blockchain.

In another aspect, the platform components may include a landlord direct component. The landlord direct component may include a renter search aspect to locate the renter prospective to engage in the transactional relationship. The landlord direct component may include a record keeping aspect to log at least part of communications between parties, the at least part of the communications being storable in the database. The landlord direct component may include a renter community aspect to facilitate the interaction between at least the renter, additional renters, and the landlord, the interactions being storable in the database. The landlord direct component may communicate with the matching component to connect the renter having an acceptable likelihood of compatibility with the landlord. The information relating to the renter having the acceptable likelihood of compatibility may be storable in the database. The platform components may include a landlord management component. The landlord management component may include a landlord financial aspect to receive payments from the renter. The landlord management component may include a maintenance request aspect to receive a maintenance request for the real property unit. The landlord management component may include a landlord-vendor management aspect to request service from a vendor, manage costs to the vendor, and log the interactions with the vendor. The landlord management component may include a tenant exchange to transact rights to a tenant of the transactional relationship. A lease negotiation component may be included to assist a renter with uploading pictures of the unit for the community to view or compare against pictures of the unit provided by the landlord. An assembly of renter pictures may be combined using software to create a 3D or virtual reality experience, for example using photogrammetry, advantageously avoiding the need to hire a dedicated 3D or VR professional to digitize the apartment for validating the accuracy of the information provided by the renter and/or the landlord. This information may be included in a block, which may be added to a blockchain in a decentralized manner. Additionally, ratings and/or reviews may be decentralized so that they may be authentic, true, and protected from manipulation.

According to an aspect of this disclosure, a method of facilitating a transaction via a cryptographic system is provided. The method may include (a) communicating data and rules stored in a database decentralized among a distributed ledger and accessible via a network by platform components, the data relating to a transactional relationship, and the rules being at least for determining a likelihood of compatibility between parties to the transactional relationship. The method may include (b) managing a renter profile including renter information by a renter component and analyzing at least part of the renter profile to derive a renter score for association with the renter, the renter score being includable by the renter profile. The renter profile may be includable by the database. The method may include (c) comparing at least part of the renter profile and information indicative of renter behavior to the rules by a matching component to determine whether the likelihood of compatibility with a landlord requirement relative to a real property unit meets a matching threshold. The method may include (d) matching the parties for which the matching threshold is met. The method may include (e) selectively assuring financial stability in the transactional relationship via a guaranteed rental income protection. The rules may include a threshold of eligibility for the guaranteed rental income protection. The guaranteed rental income protection may be selectively offered for the transactional relationship that meets the threshold of eligibility. The system may include a token exchange aspect to coordinate sharing of at least part of the renter profile at least partially identifying the renter with the landlord. The renter may grant access to an authorization token for the landlord of the real property unit for consideration for the transactional relationship. The authorization token may be revocable. The system may include an interface accessible to interact with the data and at least one of the platform components. A renter score may also at least partially include behavior analytics, which may be encrypted and shared in a blockchain.

In another aspect, the method may include (f) assisting an agent with the transactional relationship by a broker-assisted component. Step (f) may further include (i) at least partially automating tasks related to the transactional relationship using a smart contract, (ii) operating with the matching component to substantially identify the renter with the likelihood of compatibility for the landlord with the real property unit in consideration for the transactional relationship, and (iii) coordinating sharing of at least part of the renter profile from the renter to the landlord via the token exchange aspect.

In another aspect, the method may include (g) assisting the landlord with the transactional relationship by a landlord direct component. Step (g) may further include (i) locating the renter prospective to engage in the transactional relationship relative to the real property unit, the renter being filterable by the renter score, (ii) communicating with the matching component to connect the renter having an acceptable likelihood of compatibility with the landlord, and (iii) coordinating sharing of at least part of the renter profile from the renter to the landlord via the token exchange aspect. The system may include a landlord management component, which may include a landlord financial aspect to receive payments from the renter and a maintenance request aspect to receive a maintenance request for the real property unit.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative transaction assistance system, according to an embodiment of this disclosure.

FIG. 2 is a block diagram view of an illustrative computerized device, according to an embodiment of this disclosure.

FIG. 3 is a flowchart view of an agent management operation, according to an embodiment of this disclosure.

FIG. 4 is a flowchart view of a lead pool transaction aspect of the agent management operation, according to an embodiment of this disclosure.

FIG. 5 is a flowchart view of an applicant management aspect of the agent management operation, according to an embodiment of this disclosure.

FIG. 6 is a flowchart view of a team management aspect of the agent management operation, according to an embodiment of this disclosure.

FIG. 7 is a flowchart view of a landlord direct operation, according to an embodiment of this disclosure.

FIG. 8 is a flowchart view of a landlord management operation, according to an embodiment of this disclosure.

FIG. 9 is a flowchart view of a renter operation, according to an embodiment of this disclosure.

FIG. 10 is a flowchart view of a broker-assisted renter operation, according to an embodiment of this disclosure.

### DETAILED DESCRIPTION

The following disclosure is provided to describe various embodiments of a decentralized cryptographic real estate transaction assistance system and method. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

Various aspects of the present disclosure will now be described in detail, without limitation. In the following disclosure, a decentralized cryptographic real estate transaction assistance system and method will be discussed. Those of skill in the art will appreciate alternative labeling of the decentralized cryptographic real estate transaction assistance system and method as a rental platform, real estate and rental facilitation system, real estate, contract, behavior, and income backed financial system, transaction system, real estate focused social media and review system, property management software, real estate sales force and team management system, substantially full service renter and broker facilitation system, real estate vendor management system, substantially automated real estate transaction services platform, quotient-based transaction services and electronic registry, substantially full service landlord and tenant system, property rental matching and application platform, landlord management system, blockchain real estate platform, the invention, or other similar names. Similarly, those of skill in the art will appreciate alternative labeling of the decentralized cryptographic real estate transaction assistance system and method as a property rental facilitating process, real estate coordinating and communicating method, renter analysis and matching operation, lease offer finding services, income-based pre-approval services, method, operation, the invention, or other similar names. Skilled readers should not view the inclusion of any alternative labels as limiting in any way.

Some common definitions will be used throughout this disclosure, which will control over all other sources. Real property unit, or alternatively unit, is a property available for rent or currently rented, for example, with vacancy, occupied, or not occupied. Transactional relationship is a rental agreement, lease, sublease, corporate lease, or optionally real property purchase agreement. To transact includes buying, selling, trading, transferring, and other transactional activities. Party includes at least renters and landlords. Renter is a party looking for a rental unit, not yet in a transactional relationship. Co-renter is a person affiliated with the renter also looking for a rental unit. Tenant is a person in a rental agreement with landlord for a unit, also referred to as a leasee. Co-tenant is a person affiliated with the tenant also in a rental agreement with the landlord for a unit. Roommate is a person that lives in a rental unit with the tenant, without consideration whether the roommate is also a co-tenant. Applicant is a renter applying to become a tenant. Co-applicant is a person affiliated with the applicant that is applying to become a co-tenant. Landlord owns at least one unit to be filled by a renter or has filled a unit with a tenant. Co-signer is a person jointly signing a document, often guaranteeing a financial responsibility. A guarantor is one that guarantees the transactional relationship. In applications relating the sale of real property, the landlord term may be substituted with seller and the renter term may be substituted with buyer. An agent may facilitate matching a renter with a landlord with intent that renter will become a tenant of the landlord's unit. Agents may be affiliated with a broker. Vendors may provide services to a landlord for the rental unit. User includes all parties and others that may use the platform, including renter, tenant, landlord, broker, agent, and other entity. Worked lead refers to a potential renter or applicant that has progressed through at least part of the registration and approval process, which may include qualifying for an available real property prior to submitting an application.

Some additional definitions will be used throughout this disclosure with respect to embodiments including aspects of decentralization, which will control over all other sources. Decentralization means the storing of information across multiple virtual locations, which may occur over a network. Cryptographic means using a feature to ensure the validity of data received, stored, and/or transmitted. Cryptography may include a cryptographic hash function, which may produce a unique hash value for a variable-size transaction input, for example, a SHA-256 computational algorithm.

A distributed ledger may include ledgers with data stored across the network. Points on the network including aspects of the distributed ledger may be called nodes. The network across which a distributed ledger may be shared can be called a distributed network. A decentralized autonomous organization is a group or organization capable of operating without centralized and/or managed human intervention. A smart contract is a collection of terms that may be assigned conditions, where aspects of the smart contract are automatically or substantially automatically executable upon compliance with those conditions. Smart contracts may be written in computer code. Portions of smart contracts and data included by a distributed ledger may be stored on a node, which may be a participant of a blockchain network.

A blockchain may include a distributed ledger substantially permanently recording information in the form of blocks added to previously recorded information, which may create a chain of blocks of information. The blockchain may include a substantially complete history of all information added to the chain, which may be quantified by a block height. A block reward may be offered to incentivize parties, for example miners, to provide computational power to validate information stored in the blockchain and/or analyze such data. The computational power may be at least partially defined by a proof of work requirement respective to the expense of computational calculation required to solve an algorithm or operation relating to authentication of a transaction and/or handling of data. An oracle may be provided as a bridge between data existing outside of the blockchain and data included within the blockchain. For example, an oracle may include a data entry, a sensor, or connection to an application programming interface (API), without limitation.

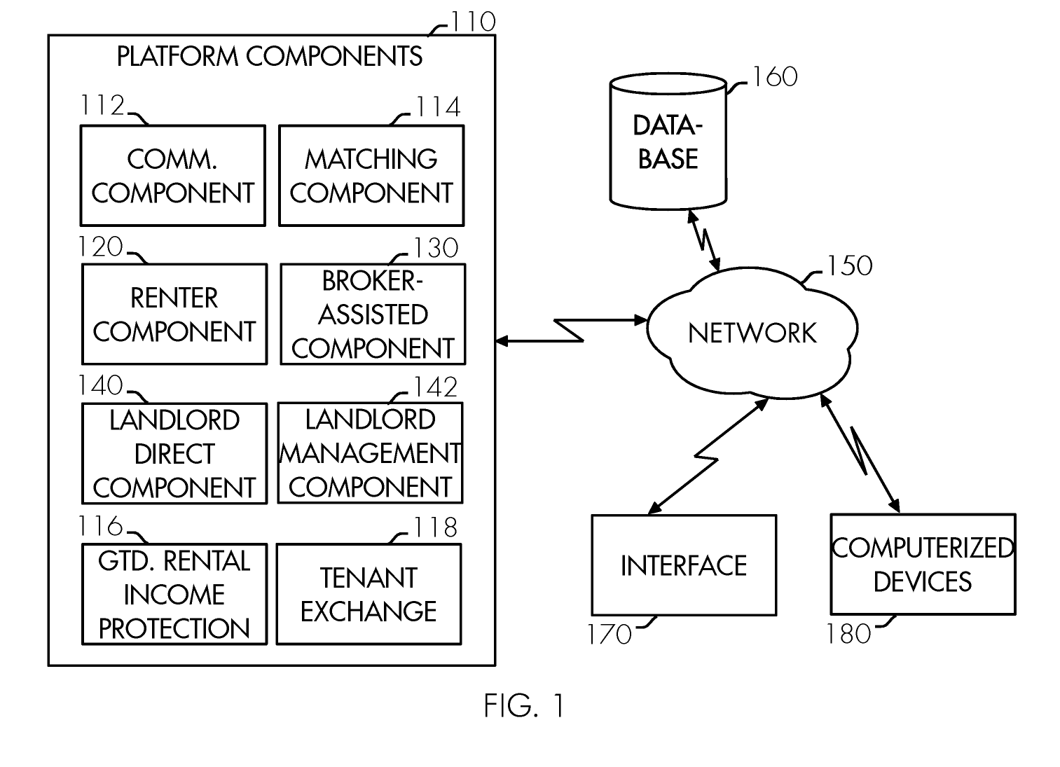

Referring now to FIGS. 1-9, the decentralized cryptographic real estate transaction assistance system and method will now be discussed in more detail. The decentralized cryptographic real estate transaction assistance system and method may include a property rental and real estate transaction assistance platform, database, platform components, renter component, matching component, communication component, broker-assisted component, landlord direct component, landlord management component, lead marketplace component, guaranteed rental income protection, renter profile validation aspect, tenant exchange, and additional components and aspects that will be discussed in greater detail below. In some embodiments, the renter component may include the matching component. The decentralized cryptographic real estate transaction assistance system and method may operate one or more of these components interactively with other components to facilitating matching, engaging, contracting, and communicating between parties to a real estate and/or property rental transaction by a network-leveraged system.

The property rental and real estate transaction assistance platform will now be discussed in greater detail. FIGS. 1-9 highlight examples of the property rental and real estate transaction assistance platform, which may also be shown in other figures. Data may be shared among components, the database, and other aspects of the platform.

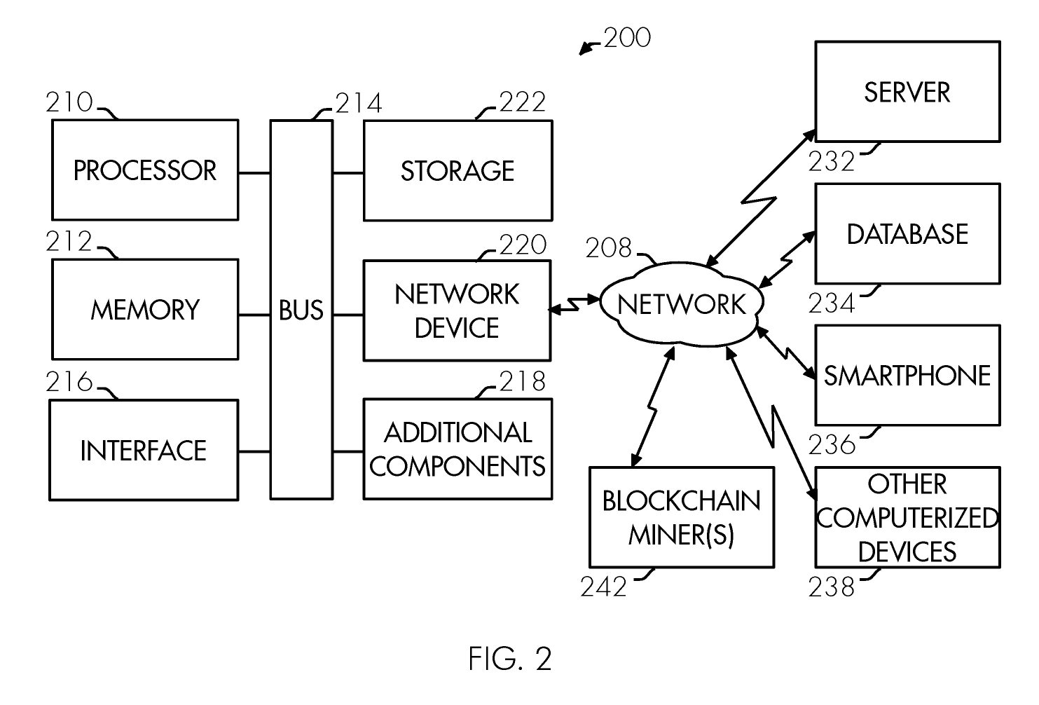

The database will now be discussed in greater detail. FIGS. 1-2 highlight examples of the database, which may also be shown in other figures. Data may be storable in one or more connected databases 160. The databases 160 may be connected via a network 150, for example, the Internet. Data may be accessible from the database 160 by one or more of the platform components 110, an additional database, computerized device 180 operating one or more aspects of this disclosure, an interface 170 facilitating interaction with the database 160, and/or other points of access.

The database 160 may include rules to affect operation of the connected platform components 110. For example, the database may include rules to determine whether a renter and a landlord or a tenant and landlord have a sufficient likelihood of compatibility to suggest the parties be matched. In another example, the rules may be used to analyze data and derive a comparative metric, such as a renter score. The renter score may include a measure of risk associated with a renter. Additional examples of rules will be provided throughout this disclosure. Furthermore, those of skill in the art will appreciate even more rules that could be included by the database, without limitation.

The interface will now be discussed in greater detail. FIG. 1 highlights examples of the interface, which may also be shown in other figures. The interface 170 may provide functionality to a user to access, interact, modify, and otherwise benefit from data stored in the database 160 and/or manipulated by one or more of the platform components 110. The interface 170 may be operable by a computerized device 180, for example, a computer or a mobile computing device. Illustrative computerized devices are discussed in greater detail below.

The platform components will now be discussed in greater detail. FIGS. 1 and 3-9 highlight examples of the platform components, which may also be shown in other figures. The platform components 110 may interact with the database 160 to access and manipulate data. The platform components 110 may connect to the database 160 via a network 150, for example, the Internet. A user may interact with the platform components 110 using one or more aspects of the interface 170. The platform components may include a communication component 112, matching component 114, guaranteed renter income projection 116, tenant exchange 118, renter component 120, broker-assisted component 130, landlord direct component 140, landlord management component 142, tenant community social and commerce component, and/or additional components and aspects that would be appreciated by a person of skill in the art after having the benefit of this disclosure. The tenant community and renter community may share features and membership, partially share features and membership, and/or provide discrete features and membership. Examples of the components provided by the platform will be discussed in greater detail below.

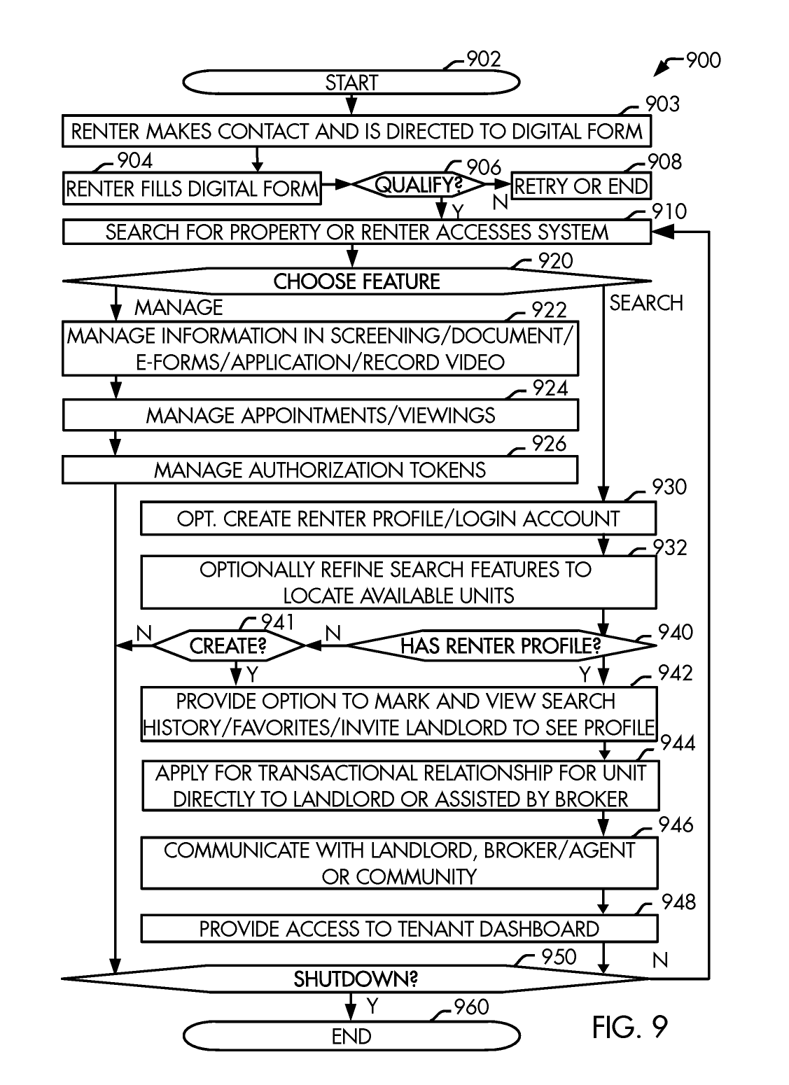

The renter component will now be discussed in greater detail. FIGS. 1 and 9 highlight examples of the renter component, which may also be shown in other figures. In some embodiments, the renter component may include the matching component. The renter component 120 may include various aspects to assist a renter using the platform of this disclosure. For example, the renter component 120 may include a renter profile, renter score, renter profile validation aspect, rent payment history, reviews, ratings, time accumulated in system, and other aspects.

The renter component 120 may be called once a renter initiates/reinitiates the service provided by the platform. For example, a renter may use a phone or computer access the renter component via call, text, or access of a portion of the interface. If the renter accesses the interface 170, such as on a webpage or advertiser landing page, the renter may provide information useful for performing the search. For example, the renter may provide personal profile information, search criteria, or other information to substantially simultaneously register and be matched to apartment vacancies meeting their initial search criteria. Forms may be provided to receive the information from the renter.

To apply and be considered for the apartment, the renter may be instructed to complete their application, screening information, upload documents, verifications, and/or optionally get a guaranteed rental income protection (GRIP) pre-approval letter. Completion of the application may include a pre-screening or fasttrack, which may include a basic search criteria form that may be provided via an interface accessible by the renter. These steps may be performed from a renter's customer login page of the interface. The renter may also create a digital profile, which may include video or other media. If the renter does not pass the automated review process, the renter may update and/or resubmit information for subsequent review. The renter may communicate with an agent directly through the renter's account, rate an agent, landlord, or unit. In one embodiment, the renter may invite a landlord to view their renter profile directly through the account.

An illustrative renter onboarding aspect of the renter component will now be discussed. Renters can onboard by accessing interface pages shared with a landlord direct component and/or broker-assisted component, which will be discussed in greater detail below. Alternatively, renters may onboard by calling and/or texting an advertised phone number to receive a link, webpage, physical address, or instructions, such as via a text message link, email, or mobile app to input initial search criteria via the interface. Without associating the initial search criteria with a renter profile, the renter may be restricted to entering basic search information and not obtaining an instant auto-criteria matching, time-saving process. From this aspect of the interface, the renter may choose to search for units listed directly by landlords via the landlord direct component or broker-assisted units via the broker-assisted component 120. In one embodiment, the initial search criteria form, for example fasttrack form, may provide renter with useful info about search area, occupancy and income qualification for units in renter's specified areas, before renter proceeds with the process, saving renter time and teaching the renter about local rental market prices. Fasttrack data may be used to pre-screen and for auto-matching to unit.

At least part of the renter information associated with the renter may be analyzed prior to granting access to directly engage landlords. The renter may be requested to complete a screening questionnaire and provide relevant information for review and validation to assemble data for the next stage of the process and/or until enough data is collected to establish the initial renter score. Requested information may include income, family size, creditworthiness, regulatory restrictions, references, rental history, ADA, pets, vouchers, criminal registration, area limitations and other information. Additional information may be requested if needed, for example, to validate a renter's assertions. Subsequently, the renter may complete an application form and service agreement, upload relevant documents, send and submit employment and rental verification if appropriate, search apartment listings, vote or comment on erroneous listing information, vote or comment on landlord and/or agent/brokerage services, vote or comment on other user suggested listing changes, and/or otherwise interact with the features provided by the renter component. The renter may share access/invite to renter account co-renters, co-signers, other renters, landlords, and/or agents. The renter may communicate with agents, renters, landlords, and/or other parties.

The renter may contact landlords or brokers, respective to the path selected by the renter, review and rate their experience, and/or invite landlords to view their renter profile. Renters may also apply to be awarded a GRIP certificate for lease offer from their chosen landlords. Including a granted GRIP certificate, which may enhance a rental application by assuring financial security. Guaranteed rental income protection (GRIP) may give renters an advantage over other applicants and give the landlord piece of mind.

Some renters applying may not be qualified. Higher risk applicants may not instantly qualify under the renter component process and may default to the broker-assisted process for additional assistance. Brokers using the broker-assisted system may interact with the broker-assisted component for applicant process support. The broker-assisted component may operate substantially in parallel with the landlord direct component, allowing renters to toggle between these components substantially seamlessly. The platform may share data and previous work stored in the database to the various platform components.

If the renter is disqualified from accessing the landlord direct component, the renter may be substantially automatically sent notice of disqualification and directed to proceed through the broker-assisted process.

The matching component will now be discussed in greater detail. FIGS. 1 and 3-9 highlight examples of the matching component, which may also be shown in other figures. In some embodiments, the renter component may include the matching component. The matching component 114 may compare at least part of a renter profile to available listings to determine a likelihood of compliance with rules associated with the listed unit. The matching component 114 may consider renter information associated with the renter profile, renter score, whether a GRIP certificate was granted, reviews, history, governmental or regulatory restrictions, rules associated with the lease, occupancy limits, pets, rent, income-to-rent ratios, smoking, ADA compliant, floor level requirements, vacancy date, price, number of bedrooms/bathrooms, search area, and other renter information. Governmental and regulatory restrictions may include sex offender status, whether the renter needs a home office, pet breed, and other restrictions.

The renter score will now be discussed. The renter score may provide renters and landlords with transparency and lead to a faster process by providing a reliable measure of a renter's preferences, riskiness, based on factors commonly reviewed by landlords. Those factors may extend far beyond credit line payment history reporting offered by a FICO credit report, especially since FICO reports commonly do not reflect rent payments. Since rent payment is often the largest expense for a renter, its payment performance history can forecast future rent payment performance. Additionally, renter behavior regarding their landlord, landlord's staff and contractors, neighbors, and a renter's maintenance and payment history can affect the reliability and risks associated with the renter. For example, a renter that pays on-time but spends all night aggravating his neighbors is just as likely to get evicted as if that renter didn't pay rent. In another example, a renter that continuously damages the unit, deals drugs from the unit, or behaves in a manner that makes neighboring units unattractive to future tenants may decrease their marketability as a renter. Therefore, the renter score provided by this disclosure advantageously provides a substantially total summation of the rentability of an individual. The renter score may be integrated into a tenant score once renter becomes a tenant and may be a composite score or broken down into an individual score by condition or segment and by rental status.

To determine a renter score, the renter may be provided a renter questionnaire. Responses may be analyzed to determine a renter score for the renter. The renter score may be associated with the renter profile of the renter. The renter score may be modifiable upon analysis of subsequently received information, a change in circumstance, criteria, or profile for the renter, and/or through other actions taken by the renter. From the renter first completing an initial search to exiting a tenant lease and moving out of a landlord's unit, the platform of this disclosure may track, accumulate, aggregate, and calculate data, reviews, and ratings made by the renter and connected parties. A renter and/or tenant score segment may include but are not limited to: interview score, payment score, maintenance score, behavior score relating to other tenants, behavior score relating to landlord, maintenance staff, agents. Renter scores and/or tenant scores may include renter history such as: employment history including income amount and duration of employment and income trajectory, rental payment and duration renting, payments to creditors, assets and ability to accumulate savings/assets, evictions, types of evictions, causes of evictions, criminal history, crime types, causes of crime, education/certification, military service, handicap accessibility, pet training certificates, ESA, etc. In an embodiment using a decentralized system, information about the renter score and the renter may be added to a distributed ledger, for example, as included by a blockchain. Rent payment may be paid with a cryptocurrency earned as income or credit for good behavior and maintaining a tenant score threshold, paying rent on-time, early, and reducing maintenance cost and landlord's financial expense.

Renter score may be affected by rental payment history. The platform may provide an interface for electronic payment of rent, use of which may be tracked and may affect a renter score. If payment is received outside of the platform, it can be recorded by a renter/tenant and/or landlord on their respective logins. If a rent payment recordation entered by the renter and landlord mirrors several factors, for example, paid amount, payment date, and/or form of payment, or if the payment information is confirmed to be true by the reviewing party, the rent payment may be verified as likely accurate. A rent payment receipt may also be uploaded for safekeeping and future reference in case of questions or dispute. Recordation may also affect the renter score and may allow renter to enjoy continuity of service. The renter score may also increase in value as experiential data builds to benefit for the next lease or mortgage financing.

The renter score may be derived from, but is not limited to, some or all of the following: user data from forms and supplied documents, renter/landlord/vendor/neighbor interaction and ratings, the search (interview, negotiation, lease signing). The tenant score may be derived from or incorporated into a renter score and is not limited to the following considerations: tenancy (renter history, payment performance, maintenance demands, community page peer reviews, reviews about/by landlord, etc.), exit (apartment condition, did tenant leave in a timely manner, was departure pleasant, was there a balanced owing, where there are legal fees or contested amounts, etc.), and other factors. Rating and review data may be organized, calculated, weighed and/or incorporated with renter's other data to affect the renter score. This information may be included in a distributed ledger, without limitation.

Rating and review features may be available and used to rate participants (renters, tenants, vendors, landlords) during maintenance issues. Ratings relating to landlords and/or vendors may also be considered by the renter score, landlord scores, and vendor scores. For example, negative remarks by a vendor with a low vendor score may have less weight than a vendor with a high vendor score. These scores may be shared to provide transparency on possible outcomes of future business engagements, deals, promotions, access to services and more. Ratings and reviews made relating to renters may affect the renter score of the renter/tenant. Renters may rate practically everyone and every service and product they interact with. These ratings and reviews, created by and received by renters, may be aggregated into the renter score, which may consider/use for/in behavioral analytics and predictive modeling. Users who are consistently negative may have reduced impact on businesses, vendors, landlords, and/or tenants they rate.

The renter score may be used to determine how much a renter will pay in service cost, rent cost, GRIP plan cost and duration, renter discounts and incentives, and more. Rewards may be awarded to renters who have a low risk renter score, allowing renters/tenants to earn discounts and enjoy goods and services at reduced rates. Renter score, which may be interchangeable with a tenant score, may also be used to issue lines of credit and other financial instruments and/or currencies. GRIP eligibility may indicate an applicant has met risk guidelines. Supplemental Information may be necessary from the renter to keep GRIP eligibility. GRIP eligible renters/tenants may be provided a GRIP card to get an instant approval to rent, make purchases, and get access to discounts and promotions. Tenants may also qualify for GRIP to ensure lease continuation, resigning, or to qualify for rent reduction, for example.

Time spent using the platform may create intrinsic value in the renter score and may facilitate iterative accumulation and recalculation of relevant data. Renter's/tenant's ratings and reviews, timely rent payment history, frequency and severity of property damage, other factors attributing to income, cost, and quiet enjoyment of other tenants may be factored into the tenant score and into the composite renter score. The renter score may also be used to establish credit profiles and access to financial services and instruments offered to a renter. Financial instruments may be offered through the platform, which may be backed by another entity. The financial instrument aspects may offer a variety of debt instruments. Types of credit and amount of credit may be determined by the renter score, which may be indicative of experiential transaction data and behavioral analytics.

Risk modeling provided by the platform may additionally expedite renter applicant rental process by providing rental income protection for landlords. The risk modeling may additionally provide a tenant exchange where lease contract transaction may be packaged and sold as short-term securities on global exchanges. Lease contract transactions may be valued by the tenant/renter score. This behavior-valued security may be traded on an exchange. The risk modeling may create renter-based credit system to underwrite financial instruments for renters, tenants, landlords, agents, vendors, and/or others. The risk modeling may additionally improve the odds for an enjoyable rental experience for the parties, benefiting from reduced time and cost of a rental process.

Risk modeling, which may be based on analyzing data collected for a user based on interaction with a platform enabled by this disclosure, use of GRIP, feedback from the community, reviews, ratings, external sources, user-supplied information, and information from other sources, may advantageously assist with risk and behavior modeling. This data may be analyzed to predict future behavior, thus affecting risk determination. For example, the risk modeling aspects of this disclosure may assist with determining whether a renter or buyer may qualify for a desired transactional relationship. This risk modeling may determine, for example, if a renter is credit and/or income ready for a requested transactional relationship. The risk modeling may additionally cultivate tenants and renters into future buyers, facilitating the application, issuance, and use of credit for a real estate or other purchase at least partially based on the analytics of data gathered during a previous interaction, for example, a transactional relationship relating to tenancy of a rental unit. Reporting may be provided to renters and/or tenants to help them understand how their behavior is recorded and effecting their score, opportunities, options, and cost or expense, and may include information on what they may do to improve their score.

A renter may advantageously monetize their renter score by receiving promotions and discounts on goods, services, rent, credit lines, credit cards, cryptocurrencies, other financial instruments, financing options and more. These offerings may be based on the renter score associated with the renter.

Landlord profiles will now be discussed. The matching component may also analyze a landlord profile, which may include an associated landlord score. A landlord profile may include background data, user ratings, risk score, payment score, reviews, and the renter score of the landlord's tenants. Since the landlords' financial stability is relative to the financial stability of the landlord's tenants, landlords with more stable tenants may be given a more favorable landlord score. Landlords with a sufficient landlord score may be provided more opportunities for promotions and discounts on goods, services, credit lines, credit cards, financial instruments, financing options, and more. The landlord may additionally be associated with profile continuity to incorporate user reviews about landlord performance for future use. Landlord reviews about renter performance, number, severity, and frequency of maintenance issues and speed of resolution, and other factors may assist with GRIP issuance to renters and landlords. Landlords may not qualify to receive GRIP if their landlord score indicates a high risk of default, attributed to but not limited to, improper maintenance, unprofessional behavior, debt maintenance risk, payment risk, property/casualty risk, and more.

GRIP benefits to landlords may include access to alternative options to finance commercial property, other than to be forced to borrow consecutive balloon loans, which are typically costly and disadvantageous to landlords due to the manner with which balloon loans operate. Leveraging GRIP, landlords will be able to provide confidence and stability to lenders, which shows rents are backed and that resulting income stability may warrant lower costs and alternative financing that may be equal to or better than options provided to residential homeowners.

Predictive behavioral compatibility (PBC) models may affect analysis to determine a likelihood of compatibility between a tenant and a landlord, and tenant and tenant. Comparative attributes of the tenant and the landlord may be considered in the PBC analysis and may influence the issuance of GRIP. The PBC models may be used to determine landlords/renter compatibility, reduce lease default, and increase satisfaction in renter/landlord business transaction relationship. Reviews from tenant, vendor, and landlord may be used in PBC modeling for compatibility analysis and actuarial purposes. Management staff and maintenance staff that administer over, or interact with, tenants may be rated, reviewed, weighted, and/or factored into the PBC model. This information may be included in a distributed ledger, without limitation.

The communication component will now be discussed in greater detail. FIGS. 1 and 3-9 highlight examples of the communication component, which may also be shown in other figures. The communication component 112 may facilitate communication among users of the platform of this disclosure. The communication component 112 may provide VOIP calling, virtual assistant services, SMS messenger applications, and other communication features for use with the platform of this disclosure. The communication component 112 may be used for advertising, notifications, announcements, and user purchases. The communication component 112 may facilitate connection and management of multiple phone numbers at the same time, such as through a messenger, to provide incoming and outgoing VOIP and SMS communication from one or more phone numbers in one simple to use dashboard aspect of the interface.

The communication component 112 may provide many-to-one interface features and provide access to many phone numbers using one interface. This may be especially advantageous for call centers or brokerage offices where many incoming and outgoing calls and/or text messages need to be managed from multiple agent/company owned phone numbers. This may be different from having one phone number and multiple extensions. There may advantageously be no additional hardware installation required. The communication component may additionally interface with a virtual assistant, allowing users to customize communications, set recorded messages, dial prompts, office hours, incoming call and SMS filters, automated text and voice replies, call forwards, and other features. A system enabled by this disclosure may be a standalone system or linked to landlord, agent, vendor accounts mentioned elsewhere in this disclosure.

The broker-assisted component will now be discussed in greater detail. FIGS. 1 and 3-6 highlight examples of the broker-assisted component, which may also be shown in other figures. The broker-assisted component 130 may include various aspects to facilitate interaction between an agent and one or more parties to a real property transaction. The aspects may include an agent-renter CRM aspect, renter qualification aspect, token exchange aspect, commission protection aspect, team module, leads modules, find broker module, find team module, sell team module, manage hierarchy module, and other aspects and features that will be appreciated by a person of skill in the art after having the benefit of this disclosure. The leads module may include referral lead transparency, selling leads, and transferring leads, without limitation.

Sharing of community resource management (CRM) data to subclasses will now be discussed. Renters become tenants when they occupy property and are in a transactional relationship with the landlord, for example, a lease. The broker-assisted component 130 may facilitate sharing data between agents, renters, tenants, landlords, vendors, and/or other entities. Star reviews created by a renter, tenant and/or agent about a landlord may be shared with the renter community (RCRM), the tenant community (TCRM), and the agent community (ACRM). Additionally, star reviews created by a landlord about renter/tenant, agent and/or vendor may be shared with the landlord community (LCRM). Star reviews created by a vendor about tenant and/or landlord may be shared with the vendor community (VCRM). Star ratings created by renters and tenants about agents, landlords and/or vendors may be shared in the renter community (RCRM) and tenant community (TCRM), respectively. Reviewing users may additionally add attachments like images, audio and video files, and document files, GIFs, and other formats to further communicate through the review, rating, and social media CRM.

The agent-renter CRM aspect will now be discussed. The agent-renter CRM aspect may advantageously automate a substantial amount of repetitive renter-related communication, processing, organization, real property showing, landlord matching, negotiating, and lease signing activities, so agents can focus on selling and marketing. Automating may streamline coordination of renters and landlords, saving parties time and money by only preparing/explaining renter profile to deliver and explain to a landlord, arranging property viewings, requesting fees, explaining the rental process, explaining renter rights and obligations, assisting with negotiation and lease signing, providing experienced information about local areas and markets, and aiding with other needs of the rental process. This may be accomplished at least in part by matching parties with an acceptable likelihood of compatibility.

This disclosure advantageously provides the first known rental lead conversion system (LCS). Leads may be substantially auto-screened, auto-prompted/managed, and moved through the pipeline to be practically instantly matched to rental property. The agent may meet the renter for intake, optionally create a video profile, review renter documents and forms to generate a renter profile which may be created through substantial automation, make the connection with a landlord, get paid by the renter in advance of the interview, send the profile to the landlord if not already sent by the renter, and if the landlord does not reject the profile, then agent may schedule/facilitate scheduling the interview for renter/landlord and/by share contact details of renter/landlord. The transaction may conclude without the agent showing the unit, without splitting commission with a cooperating agent since agent has access to a landlord database rather than an MLS. An LCS as provided in this disclosure advantageously assists agents with helping renters while making money more easily than possible with prior systems and methods.

The aspect may feature automated renter process categorization. Once a renter calls or fills out the initial input form, the system may manage and substantially automatically categorize renter leads based on whether the renter qualifies and how far the renter gets in the process, with progress stages including the renter starting with completing the intake form, screening questionnaire, document upload, form completion and verification, viewing rental information, negotiation, and lease signing.

The renter qualification aspect will now be discussed in greater detail. The broker-assisted component may communicate with the matching component to substantially automatically determine if a renter's search criteria are realistic, for example, by comparing renter-entered search elements with at least part of the renter information included by the associated renter profile. If a renter's search criteria and renter profile is at least within the lower average minimum threshold of compatibility between parties, the search may have a reasonable chance of producing a successful outcome and may proceed. The renter may be granted access to additional features of the platform. If this threshold is not met, the renter may be notified to review and correct the issues which prohibit access to the rest of the process. The system may additionally give renters the opportunity to resolve issues that resulted in the rejection of the renters' search criteria.

Once access is granted to continue, the system may guide the renter substantially step-by-step, simplifying the search and application process by splitting up tasks to not overwhelm the renter. As the renter moves through the process, the system may categorize the renter according to their progression in the overall sequence. These process categories may trigger programmed events and automated communication, as well as sequence other automated functions. These sequences may communicate and coordinate renter efforts with those of their assigned agent and/or landlord to help participants navigate the process with far less effort and confusion.

Once the screening process is done, a renter's initial risk score may be established, and the renter may be informed of a service cost. Once the renter pays the initial fee, if requested, any money collected by the system or directly by an agent or agent's office may be accounted in the accounting function accessible via the user account. Information delivered to the renter about their cost and renter score may also be made accessible by the agent. The system may receive renter inputs to perform the screening, risk assessment, profile building, property matching, and respective renter's cost/payments to use the service, if any.

The broker-assisted component may send automated renter updates, invitations, and reminders by email, app messenger, text, and/or other communication media according to where the renter is in the process and based on what messages the system received and/or sent previously. Automated communications techniques and content may be customizable in the interface features accessible to the agent/managing broker/brokerage.

An auto-criteria matching process may be provided to match the renter's search profile to any available rental unit based on the renter's provided search criteria. Once matched, the system may alert a renter/agent/landlord and may allow a renter and landlord to schedule a viewing or perform a virtual viewing. In similar instances, a managing broker acting as an agent to a renter/tenant/landlord is also considered an agent. Viewing may occur with or without the agent, at the property or virtually/remotely. Final negotiations for lease and tenancy terms may be between the renter and landlord. Viewing experiences may be rated by renter and landlord. Renters may invite participating and nonparticipating landlords to view the renter applicant's documents, verifications, credit report, renter score, renter profile, and GRIP if any offered. Once the renter and landlord are matched, the renter can invite landlords to view the renter's profile and landlord can consent to interview or reject the renter from the renter profile associated with the renter, optionally stating the reason for rejection or counter-offering to the renter.

If the landlord consents to interview a renter, then the renter can interview with the landlord to view the unit. Landlords may communicate with renters through the platform to coordinate viewings, answer questions about the unit, or otherwise grow the relationship. The renter and landlord may also agree to sign a lease for the real property unit. If the renter and landlord agree to sign the lease, the landlord may offer a month-to-month lease, the landlord may produce a physical lease, or a renter and landlord can sign an electronic lease via the renter portal. Once lease is signed, the renter becomes a tenant and may join the renter community, if provided. If rejected, the renter may attempt to incentivize the landlord by counteroffering with, for example, prepayments of rent, extra security deposit, move-in fee, or GRIP policy. A landlord may also attempt to assist the renter by selling/referring renter information on a lead pool if permitted by the renter, so that the renter may be contacted by agents and/or other landlords interested in renting or assisting the renter with the renter's search.

The commission protection aspect will now be discussed in greater detail. Renters may be required to pay agent upfront fees such as a service, processing, and/or membership fees/points to be paid upon service completion, thereby advantageously bypassing escrow requirements, yet still protecting an agent from transactional risk such as being bypassed by parties to the transaction. The fees may also be used to start the search and/or create/improve a renter profile. To incentivize rental of lower cost-units, at least some of the fees charged may be provided as a service fee, for example as an equivalent of one month's rent or an otherwise defined flat fee. Additionally, the agent may charge other fees to be held for/in and agent/brokerage escrow, for example, upon notification of the landlord's acceptance of the renter's qualifications and prior to the renter receiving landlord's contact info or property address. Related terms of service may be outlined in the renter's service agreement. Once the agent obtains a landlord's acceptance of the profile and landlord makes an offer to lease an apartment meeting the renter's criteria, the agent may get paid regardless of whether the transaction completes with a lease signing. The agent's scope of work may be reduced only to obtaining an offer for the renter based on renter's criteria and then introducing the renter and landlord to each other. For the context of this disclosure, “introducing” is defined as make at least one detail about one party known to another party.

The GRIP plan cost aspect will now be discussed in greater detail. A renter and/or landlord may be required to pay to use GRIP. Payments for GRIP may require an upfront and/or recurring fee to start, maintain, or otherwise continue policy coverage. Policy coverage may include a deductible portion due upon a policy claim. GRIP may include an insurance policy underwritten and/or backed financially. GRIP may be issued as an insurance product and/or as a corporate lease. GRIP may be created by a cooperative of renters, cooperative of landlords, cooperative of investors, and/or a combination of the above. GRIP payment may be fixed and/or variable, for example, based on a percentage of rent and/or total GRIP liability. GRIP may be issued for a definable coverage duration and/or total coverage amount. GRIP may be conditionally offered and conditionally provided/honored. GRIP may be bought, sold, leveraged, bundled, traded, transferred, factored, and/or transacted by other legal operations.

Co-application access features will now be discussed. If a renter has co-applicants, the renter can grant and revoke access to co-applicants. Once invited, co-applicants may be entitled to access substantially all the same customer features as the applicant. However, co-applicants may have no user admin rights to grant or revoke access privileges of the applicant. Applicant may reject co-applicants and co-applicants/applicants may also reject being co-applicants and become applicants themselves and invite other consumers or current applicants to become co-applicants. A co-applicant may be restricted from also having co-applicants.

Text messaging communication will now be discussed. Text messages may be received by the system that are not associated to any existing customer record, which may be categorized, sent an initial auto-reply, and if a follow up text is sent by the renter, categorized and answered with more specificity to encourage the renter to begin the process through the system. Conversations which are unanswered by the renter may also be flagged for the agent to review. A message can also be sent on a timer by selecting on which day/time a message will be sent. Message sending can be cancelled prior to sending. Once the renter's intake form is completed, a renter record may be created, and the record may convert from an unassociated account to an associated account. Incoming renter text messages may also be received by one or more phone numbers associated with a renter profile. Text messages sent by the renter may be collected in the renter profile. The platform may collect and distribute text messages from one or more company/agent owned phone numbers, to the appropriate renter account and organize those incoming/outgoing messages chronologically in a single or multiple conversation threads viewable by the agent and may also be viewable by the renter/tenant.

Traditionally, conversation threads may be grouped by subject line and in chronological order. The messenger features of the platform may organize long messages and text messages chronologically, not by subject line. Long and text messages may be grouped by date. Long message, text messages, documents, forms, and document storage may also be organized in one application, accessible from a page of the interface. Renter may record activity of their participants, including renter, co-renter/signer, agent, landlord, and/or system activity may be recorded in “timeline notes”. Renter records may be associated with long message, text messages, documents, forms, applications, agreements, receipts, GRIP, payment records, rent payment records, reviews, ratings, customer/agent/system logs, and document storage may also be organized in a customer record, risk and cost profiles, fillable e-forms, emails and messenger services, accounting, system, event log registry, agent notes and more, all available from the interface available to the agent. This information may be included in a distributed ledger, without limitation. This advantageously reduces or eliminates the need for users to rely on multiple software applications.

Renter may easily send employment and rental verification fillable e-forms to the landlord and employer directly from the renter's login. Form fields may be designated as required, preventing submission of incomplete information. Forms may, without limitation, be stamped with geo location, IP address, device information, date/time, and start/end time to show the authenticity and origin of form completion. Forms may not need to be printed, faxed, or scanned to be delivered to the customer or agent. Once employment and rental verification forms are completed, the related forms may be substantially automatically converted to a PDF document or other format, copies may be sent to the landlord/employer, renter, and agent, and a PDF may also be substantially automatically generated and saved to the document uploads section of the renter profile, for example, upon e-form completion.

Once rental data is submitted by the landlord on the rental verification form, it may also send landlord data directly to the landlord database without further input or intervention of a human operator. This operation may be performed using a decentralized autonomous organization. Saved landlord data may be used by renters in the auto-criteria matching, substantially real-time, and landlord direct process, and by agents in the broker assisted rental process. New landlords may be substantially automatically invited to register with the platform to access system features and renter profiles.

Agent-landlord CRM aspects will now be discussed. An agent-landlord CRM aspect may be provided to save, find and display landlord, property and unit data, and provide team manager features by substantially automatically delegating work to various team members, such as advertisers or landlord aggregators. This CRM also collects landlord data from various in-house and syndicated sources, such as a rental verification page, renter applications, listing pages, renter's landlord invite and input pages, agent's provided CRM, and other sources that would be appreciated by a person of skill in the art after having the benefit of this disclosure. This CRM may also be kept current by landlords, agents, and renters. This information may be included in a distributed ledger, without limitation.

The agent-landlord CRM aspects may provide auto-listing features, for example, substantially automatic publishing of listing information to popular rental applications and websites. In one example, listing information for a real property unit may be submitted by the landlord, the listing information may then be published on multiple major real estate listing media, proprietary platform media, and other in-house and syndicated products, either by the listing advertiser and/or via API or similar automation. The listing may be substantially instantly made available to the advertising team, on the agent community, and/or the renter community. Marketing/listing agreements may contain photos and promotional material. Marketing/listing agreements may also be substantially automatically generated as a PDF and copies sent to the landlord, agent, and brokerage in accordance to local real estate laws and may be saved to a landlord's account and may be accessible by a landlord and/or agent along with photos and promotional materials. The landlord may be invited to continue registration to access a full feature set on the landlord's dashboard, if a landlord profile has not yet been created. If the landlord already has an account, landlord may update, maintain, and/or use landlord's account to manage their rental property business.

The aspect may provide a CRM landlord database that allows the agent to create a one-to-many relationship, or where one landlord record can have many real property records and each real property can have many real property rental unit records. The CRM also allows an agent to rate the various landlord data categories, such as, for example, landlord, real property building and real property unit info. The CRM may also offer subscription marketing services to landlord and/or to agent/managing broker/broker to advertise real property information, to keep such atop of renter/agent search results.

The aspect may provide advanced leasing features. Renters may apply to rent future possible available real property units before the real property units are vacant and advertised on popular websites. These advanced leasing features may give renter and landlord a huge advantage over otherwise similarly situated parties. Landlords can advantageously start reviewing applications and enter into a new lease agreement early, planning a seamless transition from one tenant to another without all the hustle and bustle of dealing with volumes of applicants and without listing and/or marketing the real property unit and without income loss to landlord which may be a result of rental vacancy. Renters can reserve their apartment in advance to reduce the stress of looking for and competing with other renters for an apartment. The advanced leasing features advantageously reward preparedness and proactive thinkers.

Real property unit availability results may be displayed by a date range search. Lease ending and starting dates, expected vacancy dates, move-in/move-out dates, and/or other dates may be stored and made searchable by date range, date category, flag, and/or another variable. Confirmation of the accuracy of these dates may be made by one or more of the parties. Viewing dates may be coordinated by the tenant and/or landlord and open house events may be coordinated using the same calendar system. Move-out may be confirmed by tenant and/or landlord for use by the calendar system. This information may be included in a distributed ledger, without limitation.

The aspect may provide rental data pool features. Landlord, real property, and real property unit data may be synchronized and accessible to agent/renter/tenant/landlord. Rental data may additionally be made available to listing advertisers, verifiers, agents, and brokers. For listings, listing advertisers may use the Rental data pool to advertise listing data. This listing data may be made accessible to a listing advertiser to publish ads on various listing websites and search engines. Rights for the listing advertiser access may enable listing advertiser to work substantially independently and without direct supervision, communication, or instruction from any team member, manager, agent, broker, or landlord. The listing advertiser may advertise vacant real property units, real property units available to view, and/or real property units becoming available to lease by a lease ending calendar, notice, flag, and/or other indicator. The listing advertiser may have access to statistics data to determine advertising success and conversion rates to track and issue invoices for measurable units of work. This technique of work measurement and tracking may allow advertisers to be paid by performance, which may elevate high performing advertisers and substantially simultaneously help reduce wasteful spending on advertising. Other staff and team members may also work under the same principle, concept, and technology. Blockchain smart contracts may be used to pay advertisers and other parties to the transaction.

The aspect may provide undesirable status tagging, for example, no commission tagging. When an agent encounters a landlord that refuses to work with agents or refuses to pay commission, the agent may mark the landlord record with a tag, for example, a “no commission” tag. Tagging can help categorize landlords based on their taggable statuses, reducing the likelihood that “no commission” landlords get mixed in with a landlord tagged as “pays commission,” or landlords that are “unclassified” as whether they pay commission. Landlords may also be tagged to a hot list. For example, an agent wanting to search for a landlord by star rating or by recent real property rental unit conversion from occupied to vacancy, the agent may set filters to retrieve results accordingly. Other classifications may exist or become created/edited/deleted, without limitation.

The aspect may provide regulatory restriction status filtering features. For example, some landlords cannot afford to pass CHA housing inspections to qualify to rent to CHA and/or Section-8 tenants or other rent subsidized tenants. Landlords that qualify and rent to rent-subsidized tenants may be found through such a search filter.

The aspect may provide additional regulatory restriction status filtering features. For example, the aspect may provide a sex offender property search feature. For sex offenders, it may be difficult to find a place to live due to governmental and regulatory restrictions. For example, there are specific areas where sex offenders cannot live. In Illinois, a sex offender cannot live within 500 feet of a school, daycare, or park which has a playground. Conversely, unrestricted renters may desire to live in a neighborhood restricted to sex offenders or with a minimal number of sex offenders nearby. Furthermore, some landlords prefer not to rent to sex offenders or other restricted renters.

The platform may provide a unique polygon map and data clustering that allows renters to search for rental opportunities inside or outside of 500-foot bubble around property, schools, daycares, or park. This advantageous feature may provide renters and landlords tools to consider these regulatory restrictions, a feature that is not known to exist in prior platforms. The search map of this disclosure and filter may assist sex offenders and people who want to avoid sex offender friendly zones find a place to live.

A city block, urban block, or simply block is a central element of urban planning and urban design. A city block is the smallest area that is surrounded by street. Tenant satisfaction for their block/immediate/local area may identify to prospective renters which blocks to avoid when trying to avoid loitering, unreported crime, poorly maintained streets, and other conditions. Ratings and reviews may be made available for renters during their search and can be selected to display/factor/filter for this information to limit output or for decision making about where to live.

The aspect may analyze user profiles and categorize landlords for access to certain features. For example, once a phone number from the database is determined to not be a landlord, the phone number may be deleted from an attempted association with a landlord profile. The phone number may also be blacklisted, for example, prohibiting new profiles and records from being created with the restricted number.

Additional categorization may be performed for same landlord with related property data. If the landlord attempts to use a different phone number for new property data, such as if by creating a new phone number for a unit or property, a new landlord record may not be created under a new or existing phone number. Instead, the new property and unit record may be associated to an existing landlord profile for the given number. If a user attempts to create a new landlord, property, or unit record with a phone number and for an existing landlord record, a new landlord record may not be created under an existing phone number. Instead, this existing record may become updated with property and/or unit data and records, which may be updated, created, or added if such data does not exist in the record.

An aspect may be provided to avoid or minimize payment of co-op fees. Using data from the landlord database, agents may avoid paying the multiple listing service (MLS) fee to access real property data and rental listing data. Info on the MLS may be listed by agents. A cooperating fee may be paid to the listing agent. For the current aspect of this disclosure, agents may work directly with landlords on the landlord database that may be accessible by agents, allowing agents to earn double the commission on the same amount of effort and avoid the co-op fee. This new agent to rental property direct process may be called the rental multiple listing service (RMLS).

Agents may assign zip codes to support staff, otherwise referred to as verifiers, on an agent's team. The verifiers may contact landlords without accidentally having other team members call the same landlord record. The agent may restrict access to a verifier, not being required to give all-or-nothing access the entire landlord database to the verifier. This access restriction advantageously increases security and programmatic applications. Records may be displayed one at a time to prevent the wholesale copying of data by the verifiers. Additional technology may be used to prevent the agent's use of select mouse and keyboard features to select and copy page content.

An aspect including the landlord dashboard will now be discussed. Landlords may view and manage renter leads, renter/tenant lists, rental property, renter search criteria, renter/tenant search criteria, real property unit availability, showing calendar, maintenance calendar, lease start/end calendar, rent payment calendar, move-in/out calendar, and other data via the landlord dashboard. The landlord may invite a renter or a tenant renting elsewhere to apply to a current or upcoming listing, browse searchable criteria, forms, chats, records, property maintenance requests, vendors, collect rent, choose rent collection techniques, apply for financial instruments, mortgage, lines of credit and other financing and use block chain and smart contracts to assign income/profit to expenses/disbursements, manage income/expenses/rent payment records, buy/sell/transfer leads, buy/sell real property, manage listing publications on landlord's behalf, manage tenant notices, newsletters, negotiation tools, subscription advertising features, communicate/view progress of late paid collection/process-service/eviction, manage accounting/tax preparation/filing, manage property manager/maintenance/office staff/contractor, leverage factoring of rent receivables, and perform other operations. The landlord may register, add, edit, or otherwise modify information for a real property unit. The landlord may also respond to renter/tenant messages and questions via a chat or messaging feature of the landlord dashboard. The landlord may access a lease form, lease record, documents, application forms, ratings, reviews, risk score, GRIP info if any, and other information associated with the landlord or a prospective transactional relationship via the landlord dashboard. Landlord may issue rent discounts or perform as an advertising media for tenants to earn advertising income from companies. Advertising media may be brokered and paid to landlord based on real property location, number and type of renters, rent amounts, renter criteria, and/or tenant ratings/reviews. Landlord may earn an income for providing access to advertisers. Advertising may be included in newsletters, billing statements, periodic updates/announcements, and more. Landlords and tenants can opt in/out. Landlords and tenants can be paid to watch/opt in to receive/send advertising. Rates can be negotiated and brokered through bidding/auction. Monthly subscription may be paid to not receive advertising.

Landlords may add themselves to the platform-connected database for “auto-criteria matching” and/or “auto-listing.” If landlord data exists for a landlord, the landlord may claim the data and edit/update their profile. The landlord may create a new record by registering or completing an online form without needing to register. If a property record exists and/or is claimed by another person, the landlord may upload evidence of ownership to claim the data record to associate with the profile with the correct landlord.

The token exchange aspect will now be discussed. A renter applying to a landlord unit may send the landlord an invitation to authorize the landlord to review a renter profile associated with the renter/tenant. The renter may limit the authorization token with temporary access. The renter/tenant profile may be defined as accessible for a limited period, after which access may expire with duration of access defined by a system enabled by this disclosure or by a renter. Once expired, a landlord with the expired authorization token may not be able to view the renter/tenant profile under the same token unless the profile was/is accepted by landlord. If the token is ignored or rejected, profile access may be terminated under the same token. The landlord may be provided a table in the landlord dashboard showing offers received, which actions were taken, and option to message renters/tenants unless connection to tenant/landlord/renter remains blocked. Access to actual renter/tenant data may not be available if a token is expired, renter/tenant profile is rejected, or the renter/tenant withdraws/cancels/blocks authorization to view the renter profile and/or to further contact the renter/tenant.

Tokens may be associated with data included by a distributed ledger. The creation, sharing events, authorization, revocation of access, or another event associated with the token may be included by the distributed ledger. For example, data relating to access to the information included by a token may be stored in a block, which may be included by a blockchain. Access to the token described by the block may be distributed and controlled through additional blocks of the blockchain. In another example, tokens may be provided a trusted timestamp, which may be provided as a feature of the distributed ledger. The timestamps associated with the token may be distributed to multiple nodes, making the alteration of tokens substantially difficult or practically impossible. Tokens may be granted, shared, revoked, rescinded, invalidated, time-limited, or otherwise controlled.

Lease negotiation and signing aspects will now be discussed. The parties may negotiate and sign the proposed terms of the transactional relationship electronically through a structured application process before a physical or electronic rental agreement or lease is signed. Once the terms are agreed, the parties may sign the lease, beginning the transactional relationship. Rental listing data may be accessed, populated, modified, and analyzed to create a foundation for negotiation. A proposed lease agreement may be populated with listing data once a party decides to send an offer to the other party. Lease contracts may also be included in a block of a blockchain and operated as a smart contract to further automate and assist the landlord and tenant with management of the lease agreement, rights, and responsibilities stated in the lease, without limitation.

In an example lease negotiation and signing, a renter may click to apply for a unit on the platform. Existing listing data such as availability/lease start date, rent amount, pet policy, any utilities included in the cost of rent, amount of security deposit/move-in fee/pre-paid rent/GRIP, and/or terms such as inclusions, conditions, restrictions, and/or other terms written into the listing may populate in the electronically fillable lease. Once the draft lease is filled, the sender sends the offer to the receiver. Sender and receiver are interchangeable, depending on which party is sending the lease for review and which party is receiving. In this digital lease, practically every data field may be editable directly in the attachment or view of a message provided by the platform. Third party signing services or APIs may not be necessary. The lease may substantially automatically save all changes made to it. Once changes are sent, fields changed by the sender may be highlighted for ease of finding/identifying/changing/approving/rejecting by the receiver. Changes may be restricted after lease is signed by all parties to the contract unless mutually agreed to void, rescind, modify, add terms, edit terms, delete terms, conditionally or immediately. This information may be included in a distributed ledger and/or smart contract, such as with the assistance of an oracle, without limitation.

The lease may be provided as an attachment. In the lease attachment, sections of the lease may contain speech bubbles to identify comments where parties can start a conversation thread on the topic of a commented section. Messages may remain in an outgoing/sent box until there is a response from receiver or until the message is withdrawn by the sender or expired. Response may include, for example and without limitation, accept, reject, counter offer, withdraw, expired, or blocked. Once a response is made, the message may be delivered to the receiver's inbox. Sent/pending requests may be stored in sent/outgoing boxes. A sender of the offer may be provided an option to withdraw the offer at any time before action is taken by the receiver. Deadlines can be set to complete the lease. Failure to timely complete the lease may trigger automatic expiration. Lease expiration warning notices may be provided to receiver and sender. Lease extensions and other changes may be possible under mutual consent of the parties to the lease.

Renters may be provided access to substantially real-time landlord data. Renters may also influence this data by providing feedback for landlord data created by or made available to renters/tenants, such as in the renter/tenant community, is accurate and current and can be made accurate through peer-to-peer feedback and/or sharing. Collectively, the renter/tenant community may review and update current data in substantially real-time by voting on a suggested change/correction until this suggestion replaces current information. Renters may also flag a record for deletion. Flagged records may be reviewed or deleted substantially automatically, depending on circumstance.

In one example, multiple renters/tenants may talk to the same landlord and get information that is contradictory to the information available to the renter/tenant community. This community may update that data to become more accurate. Users may vote to pass a change or reject a change suggested by a renter. Renters/tenants may receive points for suggesting changes that receive favorable votes. In a more specific example, provided without limitation, a unit may be listed at $1000. Other renters/tenants may learn the unit is stated by the landlord to be $1100. A renter/tenant may comment on the rent price setting the suggested price to $1100. Other renters/tenants may confirm that comment by making an affirmative vote. Once a confirmation threshold is reached, this field may become updated to reflect the suggested price of $1100. Renters may likewise vote to decline the suggestion and the field will remain in its originally posted price until an affirmative vote count is met of $1000 or another suggested price. Once a “decline vote” threshold is met, the suggestion may no longer be visible. Vote thresholds may be changed from time to time.

The team module will now be discussed. A team module may be provided to facilitate sharing leads among agents. An agent management aspect may be provided for assigning the agent to a managing broker. Those of skill in the art will appreciate that the term agent may vary in definition from state to state and is meant throughout this disclosure to include a licensed and managed representative in a real estate field. The term managing broker is meant throughout this disclosure to include a sponsoring broker, managing partner, brokerage, or licensed manager. A team monitoring aspect may be used to analyze statistics, manage access, association, hierarchy position relative to agent and track data relative to performance of the agent or members of the agent's team/hierarchy. At least part of the data may be associated with the agent. Agents and brokers can find, buy, sell, trade, transfer, and manage team hierarchies. Terms of sale may include restrictions on leads, views, teams, functions, and/or other details.

The virtual team aspect will now be discussed. The virtual team aspect may assist with developing hierarchy teams and leads management. Virtual teams may be used to delegate, segregate work functions, and provide transparency on each work function or customer process. Tracking, collaboration, and management may be performed by stage, by sequence, by functional process segments, or by entirety of a renter process. Agents may see a lead in their hierarchy branch. An agent in one branch may be restricted from seeing another agent's leads of a different hierarchy branch. Agents may be assigned a managing broker in a local team, however, in a virtual team one agent may have a practically unlimited number of managing brokers associated to report to an agent. Leads and work may flow up from an agent to a virtual managing broker of flow down from an agent to a virtual managing broker or agent. Virtual team hierarchy may deliver lead tracking and process tracking capability to encourage work sharing. Work sharing may benefit the customer and participating member of a hierarchy. Contrary to a local hierarchy, in a virtual hierarchy, not every agent of a branch may have the same managing broker. In a virtual team hierarchy, agent/managing broker participants may be associated and/or disassociated electronically, for example, via the platform. In a virtual hierarchy model, an agent of a brokerage may hay have a larger team than the brokerage where the agent's license is registered, sponsored, and/or employed.

The team management aspect will now be discussed. In a brokerage hierarchy, a brokerage may join a team with other brokerages and agents to expand their team hierarchy. Brokerages may see any lead in any of their hierarchy branches. Lead details may be at least partially restricted, without limitation. Brokerages in one branch may not be able to see another brokerage's leads of a different branch. In an agent hierarchy, an agent may have other agents in their team hierarchy. Brokers may be a virtual team member of an agent since the managing broker is likely to have a team of local agents to improve productivity for practically any agent who become parent of the managing broker. Agents may not manage managing brokers locally, however may manage managing brokers virtually. In some configurations, a local agent may not become parent of a managing broker. For example, a local agent may be a parent to other agents in local and virtual team hierarchy, they may be a parent to managing brokers in virtual or remote teams but may not be a parent to a local managing broker. A managing broker may have agents and managing brokers in a local and virtual hierarchy.

Agents may connect with a local association (local team) or a virtual association (virtual team) during registration, at which time agents may be requested or required to identify their state and city. If their location is same or within proximity to an office receiving invite, the agent/broker may be classified as local if invite is accepted and if same agent/broker is not already associated locally elsewhere. If the agent/broker is already associated locally, then all other associations may be classified as virtual unless an agent applies with the intent to become a local agent with that brokerage in which case if a new association is made then practically any open association with a local brokerage may become disassociated. Disassociation may lead to the transfer or abandonment of any open contracts, according to terms previously negotiated between agent and managing broker. An agent may team up with another agent in any level of a hierarchy branch, even an agent under a different managing broker or same or different brokerage or same or different branch. Joining a team hierarchy may be optional. Teams and individuals may disassociate from each other and find new teams to join or remain independent.

Teams, agents, brokers, and other job types may search and select a team and/or brokerage according to specialty and what agents, teams, and/or brokerage may offer in compensation packages. To attract agents and brokers, compensation packages can outline benefits of joining. Package benefits may be offered by brokerages, brokers, teams, and/or individual members. Packages may provide incentives for individual agents, brokers, brokerages and/or other teams to join a cooperative, collaborative, and teamwork-oriented process. An agent or other user of a platform enabled by this disclosure may use an income calculator to shop the best compensations packages offered in a specified area, field, or other classification, according to criteria such as the volume or terms entered in the income calculator. Output may be sorted by distance, estimated income amount, percentage, estimated profit, benefits, and other compensations or perks, without limitation.

A brokerage finder may be provided for an agent to search for and send an invite to join another agent, team, or managing broker. Agents may search for and apply to join another agent to become a team member of that hierarchy. Agents may also search for and apply to join an existing team in their hierarchy. Agents may search for and apply to join a brokerage and work under a managing broker in their hierarchy. In some embodiments, a managing broker may be restricted from sending an invite to join an agent. Brokerage or team finder search may filter by name, location, zip code, reviews, prospective profit, projected volume of business, specialty, skill, experience, reputation, and/or other considerations. Hierarchies may use blockchain and smart contracts for managing trust and compensation.

A branch in a hierarchy can be disassociated from a brokerage and/or agent, moved, traded, bought, transferred, and/or sold to another agent, team, or brokerage. Market rate for a team or agent may be based on team size, production, years in business, profitability, and number/type of assets, without limitation. The sale may be for the entire hierarchy or for a part of the hierarchy and may include assets/liabilities of the team/hierarchy. Leads owned within that branch or segment which is available for sale may be included or excluded from the sale or reorganization.

Income calculation may consider volume of business. The calculation may receive input of expected monthly transactions and average gross commission amount per transaction and this triggers the generation of expected income after expenses for any participating agent, team, managing broker, or brokerage. The profit potential may be determined by subtracting cost charged by the agent, team, brokerage in an offered plan. Costs may be typed into the plan and auto-calculated in the calculator to arrive to a net amount. Plan packages may be created and published for agent, managing broker, and team to attract and build and recruit teams and organizations. Teams, plan packages, agents, managing brokers, and brokerages may be rated, reviewed, and commented. Blockchain and smart contracts may be included for managing trust and compensation.

Agents, managing brokers, and brokerages may easily manage any of local and virtual team agents, contractors, or employees and teams. In one embodiment, information about these teams may be included in a distributed ledger. Each agent and broker can have their own advertiser, rental marketer, landlord aggregator, contractor and/or office staff, which may be managed from the agent's, broker's, or brokerage's login. The local hire may differ from the virtual team in that local hire contractors and employees may be restricted from association/disassociation electronically. In a local hire, digital links may be omitted for their child/parent to associate/disassociate. In one embodiment of local team relationships, quitting, hiring, and firing may be done with the click of a button.

Freelancers may include contractors and employees that may work for real estate teams, agents, managing brokers, or brokerages and may include individuals such as an advertiser, landlord aggregator, or other available contractor position. Contractors and/or employees may search for and apply to join an agent, agent's team, managing broker, and/or brokerage. A search to find a suitable employer can be performed by name, zip, reviews, or income package offered to contractors. Search results may include, ratings, compensation packages, and information about the managing broker, brokerage and/or team. Freelancers may opt to work exclusively. Teams, agents, managing brokers, or brokerages may place available jobs on freelancer job boards, invite individuals to become freelancers, review bids, hire, accept contracts, manage disputes, establish escrow to pay freelancer, manage freelancers, pay through an interface aspect, rehire and manage payment techniques, disputes, pending and closed contracts, ratings, reviews, reports, statistics, and more. Blockchain and smart contracts may be used for managing trust and compensation, as provided in other examples throughout this disclosure.

The team monitoring aspect will now be discussed. Regardless of where the team member originates, by virtual team, or by local team, they can be easily monitored and/or managed in the team manager. Performance may be tracked for agents, brokers, hierarchies, freelancers, contractors, employees, and/or others such as by the activities those members perform and those activities may be registered to a block in a blockchain.

Regarding category statistics and recording, regardless of where the team member originates, by virtual team, or by local team, the team can be easily managed in the team manager. Performance may be tracked. The performance manager may provide easy-to-manage support staff reports, showing efforts by tracking which and how many record fields are updated, created, deleted, and/or otherwise modified. Tracking may include whole record changes, field updates, and additions and/or deletions of data relating to landlord, property, and/or unit. Agents can record notes, which may be saved for example in chronological order. Furthermore, each field of a category may create system notes when updated. Automatic note creation may be provided, advantageously creating a record to resolve accidental changes or deletions for future reference. Users modifying a field or record may have their credentials associated with the change. The change may also be date and/or time stamped. Content and historical record of these notes may be included by a distributed ledger.

Statistical reports may be generated by authorized users to determine the volume of work performed in a reported period by a user. This transparency and accountability may optimally create a team culture focused on and paid for performance.

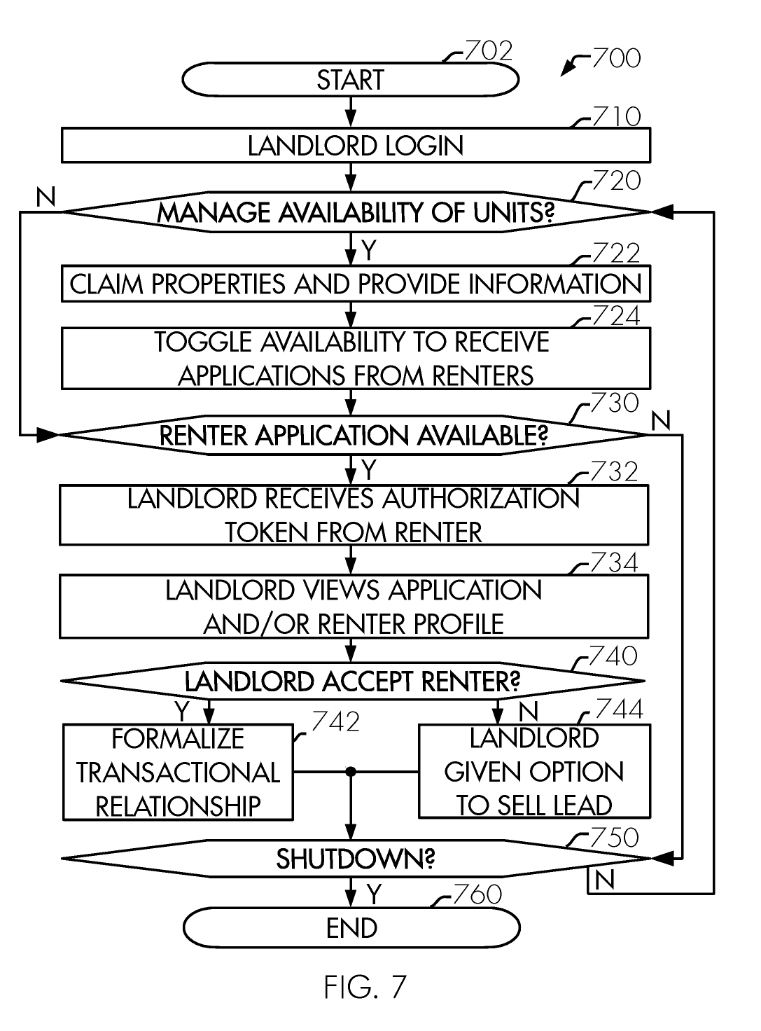

The landlord direct component will now be discussed in greater detail. FIGS. 1 and 7 highlight examples of the landlord direct component, which may also be shown in other figures. The landlord direct component 140 may share some features with the broker-assisted component 130 and other components, which are discussed in greater detail above. In some embodiments, a broker-assisted landlord component may be provided, which may include some of the structure and features of the landlord direct component and broker-assisted component provided throughout this disclosure.

The landlord direct component 140 may provide an interactive renter/landlord/vendor platform to manage the entire transaction process via a network connected interface. The landlord direct component may enable renter applicants and landlords to complete substantially the entire rental process online, starting by searching and applying to any of a voluminous number of active listings and upcoming rental opportunities on the site. Renters can then catalog and rate their unit viewings, communication experience, negotiation, and sign a lease via the platform. Once renters sign a lease, they may begin a transactional relationship with the landlord as a tenant. As tenants, they may join the tenant community to pay rent online, make maintenance requests, chat with their friends, and earn discounts on local deals. Features of the tenant community may be provided by the tenant management component 142.

Renter and tenant activities, renter/tenant profiles, renter scores, ratings, risk scores, and reviews may contribute to the data used by the payment and financial platforms discussed above. From the available portals and interface aspects, landlords and vendors may easily manage the income/expenses, communication and maintenance requests, reporting, accounting, bookkeeping, tax accounting/reporting, invoicing/collections/disputes, marketing, constant contact, newsletters, promotions, ratings, reviews, and more from their portal. This information may be includable on the distributed ledger, if included. Accounting of this information may be at least partially managed by smart contracts.

The renter search aspect will now be discussed. Using the landlord direct component 140, landlords may search for prospective renters. In the traditional process, renters contact landlords. The renter search aspect enables landlords to directly, manually, or substantially automatically search for and contact renters who match the landlord requirement for a unit. The renter score and tenant score may be connected but are not required to be interchangeable. For example, a prospective renter may be a tenant with another landlord and considered a renter until they become a tenant with the listing landlord. The tenant score and renter score may be related but may not be interchangeable in this example. Skilled artisans will appreciate additional aspects of the renter score and/or tenant score, which may be realized in alternative embodiments, after having the benefit of this disclosure.

To apply for a landlord's unit through the landlord direct component 140, rather than passively wait for renters to contact them, landlords may invite member or new renters to go through the analysis and matching processes described throughout this disclosure, allowing landlords to save time and interview/consider only qualified renters.

The record keeping aspect will now be discussed. Records may be created through interaction by the parties with the landlord direct component 140. Records may be includable on a distributed ledger, for example, as may be provided via a blockchain. Additionally, records may be created during interacting by the parties with one or more of the additional platform components 110. Records may relate to renter profiles, unit listing details, communications, concessions, rental payment history if any, employment history, saving history, ratings, reviews, compatibility score, and other information that may be pertinent to the entering of a transactional relationship between the parties. For renters that have become tenants, records may continue to be maintained relating to the tenancy, for example, rent payment amounts and dates, maintenance requests, reviews, ratings, neighbor complaints, and other information that may be pertinent to a transactional relationship between the parties. The landlord management component 142 may additionally communicate with the record keeping aspect to create and maintain records relating to the transactional relationship.

The renter/tenant community aspect will now be discussed. The renter/tenant may join a renter/tenant community. Renters may join an online renter community which may be separate from a tenant community. On a renter community, renters pay application fees, submit information for matching to a real property unit, maintain landlord's listing data in substantially real-time and have access to other information and perform other functions. After the renter signs a lease, entering a transactional relationship with a landlord as a tenant, the tenant may join a tenant community. Some community features may be shared between the renter community and tenant community, such as the features listed above. For the purposes of the renter community aspect, tenant community features may be included. Additionally, tenants may engage in commerce, use cryptocurrency within the network, submit maintenance requests, rate landlords, neighbor-tenants, vendors, local businesses, and earn rewards and discounts for being a good tenant and neighbor. Records may be includable on a distributed ledger, for example, as may be provided via a blockchain. Information may be aggregated during the renter and/or tenant community experience, at least part of which may be used to create a renter score and anticipate landlord/tenant success probability by understanding tenant/landlord and tenant/tenant compatibility. The insight provided by the renter score may leverage behavioral analytics to reduce the likelihood of lease default resulting from factors leading to behavioral incompatibility.

The renter community aspect may promote documentation and transparency. To avoid potential argument, confusion, and lack of transparency, a landlord and renter can interact on the renter community, may have recorded communication, aspect and other aspects of the platform before, during, and after they sign the lease. This documentation and transparency feature additionally promotes continuity of communication and transparency for future reference. A renter and/or tenant may upload pictures of the unit for the community to view or compare against pictures of the unit provided by the landlord. An assembly of renter pictures may be combined using software to create a 3D or virtual reality experience, for example using photogrammetry, advantageously avoiding the need to hire a dedicated 3D or VR professional to digitize the apartment for validating the accuracy of the information provided by the renter and/or the landlord. This information may be included in a distributed ledger. Additionally, this information may be included in a block, which may be added to a blockchain in a decentralized manner. Additionally, ratings and/or reviews may be decentralized so that they may be authentic, true, and protected from manipulation. Records may be includable on a distributed ledger, for example, as may be provided via a blockchain.

The renter community may provide a social media aspect of the tenant/renter community connecting renters via a tenant/renter only social network.

Records may be includable on a distributed ledger, for example, as may be provided via a blockchain. The tenant/renter community may additionally provide truth in reviews and ratings. The tenant/renter community may provide verified rating and review data. For example, ratings for a real property unit or service to that real property unit may be restricted to only tenants who've signed a lease for that unit. The tenant/renter community may also include a commerce aspect where tenants/renters, vendors, third parties, and/or landlords may purchase and engage in commerce. The commerce aspect may include a renter community marketplace where goods and services may be transacted from renters/tenants-to-renters/tenants, landlords-to-renters/tenants, landlords-to-landlords, and between renters, tenants, landlords, and/or third-party merchants. Commerce may include but is not limited to donations, investments, trade, sale/purchase, consign, loan, crowdfunding, buyer groups, and more.

The landlord direct component may additionally share aspects and features with the broker-assisted component. In some embodiments, the landlord direct component may operate at least partially with the broker-assisted components and other components to assist parties in establishing a transactional relationship and may have data sharing incumbrances. The landlord direct component may additionally allow users to share information between the components, search/invite/block users that may be preferring the other component, and/or switch at will or substantially automatically, based on conditions, to another component.

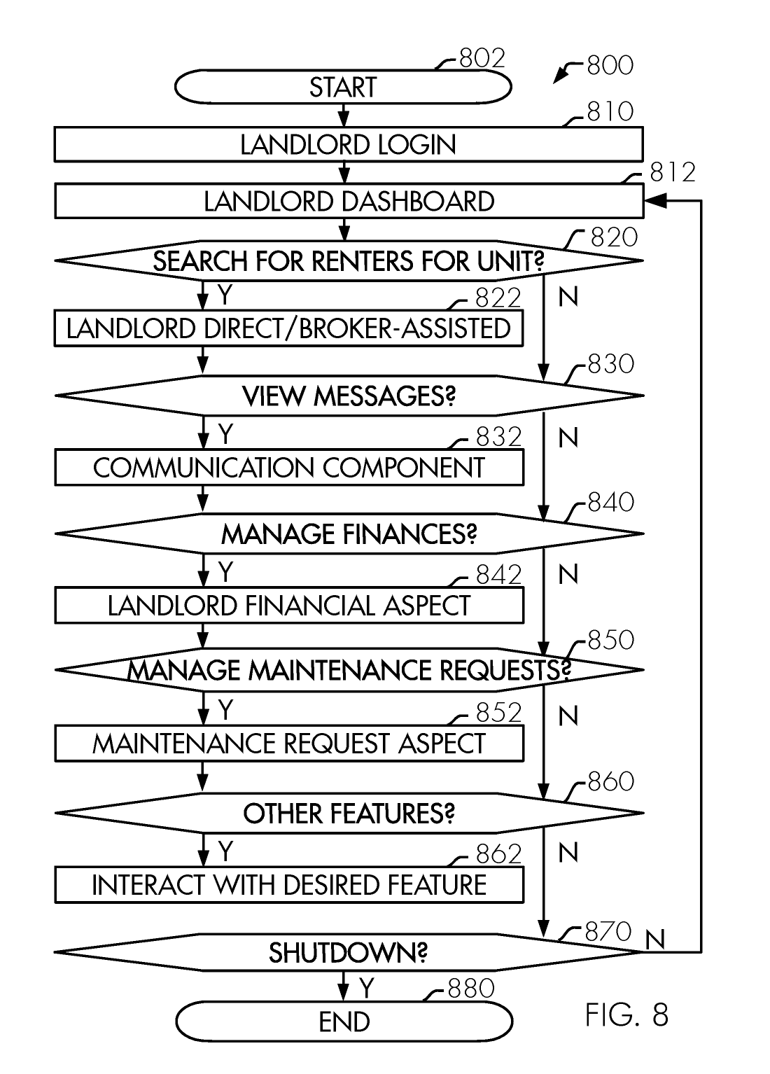

The landlord management component will now be discussed in greater detail. FIGS. 1 and 8 highlight examples of the landlord management component, which may also be shown in other figures. In some embodiments, the landlord direct component may include at least part of the landlord management component, without limitation.

The landlord financial aspect of the landlord management component 142 will now be discussed. Once renters sign a lease, they may begin a transactional relationship with the landlord as a tenant. As tenants, they may join the tenant community to pay rent online, make maintenance requests, chat with their friends, create review and ratings, and earn discounts on local deals. In at least one embodiment, rent payment and maintenance requests may be performed without joining the renter/tenant community, as well as other features may be provided independently from the renter/tenant community, without limitation.

The landlord financial aspect may provide rental payment reporting services. Tenants and landlords may use the renter/tenant score for many benefits mentioned elsewhere in this disclosure. Rental payments may optionally be reported as verified rent payments to Experian, Equifax, and Transunion (tri-merge) credit reporting services. This reporting may advantageously update rental history for renters and landlords and this reporting may be done for a fee. Renter/tenant score may be used and may eventually be recognized as an alternative to the FICO score.

The landlord financial aspect may additionally provide accounting features for landlords. For example, landlords can collect rent online and manage their income and expenses. Landlords may analyze and generate reports for profitability by property, entity, by real property building, and by real property rental unit. Any repairs completed may be billed to either the renter and/or landlord. Vendor may be paid against rent proceeds, credit card, or some other payment method. Rent payments may be monetized. Landlords may also collect rent, pay bills, and perform other financial tasks from the landlord management component. In some embodiments, a convenience fee may be charged by the platform for online rent payment transactions. Billing made to the landlord may be substantially automatically recorded to the unit cost and offset income generated by the unit, building, company for year-end tax filing purposes. Tax filing and accounting services may be provided as a product of the platform and/or third-party service.

The maintenance request aspect of the landlord management component 142 will now be discussed. The maintenance request aspect may assist a landlord to receive and manage maintenance requests relating to a real property unit and/or rental. Data from the maintenance request may be shared with landlords, vendors, renter, tenant, and agents upon request or authorization to share. The quick transmission of request data by a renter, landlord, authorized manager, or other party may advantageously reduce time to maintenance completion, invoicing, and cost payments while increasing profitability and tenant satisfaction. Vendor/landlord transaction may be partially or substantially automated by establishing an escrow amount funded by the landlord, rent, security deposit, renter/tenant, or line of credit and against which payment to vendor may be made on mutual agreement of satisfaction of a work order.

Tenants may make a maintenance request from their smartphone, for example, by taking a photo/video of the issue, categorizing the photo by the maintenance type, selecting priority level, writing the description of the issue, and/or sending the request to the landlord and/or an authorized person. Renters may also reject and schedule/reschedule/cancel maintenance appointments, review status, invoice, pay, and dispute/arbitrate through the landlord management component. Dispute and arbitration is a huge time and money saver for renters and landlords and may reduce likelihood of eviction and/or the hiring of attorneys by each party to resolve matters. Often, renters are confused about their rights and obligations, and take actions, such as withholding rent, to their detriment. Inappropriate action may be frowned upon in their legal cases and may lead to a judgment for the landlord because of the renter being unaware of how to properly solve a dispute. Arbitration may help the renter and landlord avoid situations that lead both to solve their differences in court. Negative review ratings can cause a system trigger to offer arbitration services to the dissatisfied party, which may encourage cooperation, reduce GRIP claims, and improve user ratings and overall user experience. In some embodiments, refusal to cooperate with arbitration may affect GRIP loss coverage and participating user scores.

For the landlord, once the maintenance request is received, a copy may be sent to the landlord and/or maintenance person, including but not limited to information such as the maintenance type and urgency level can be recategorized by the landlord or authorized manager. A category selected by the tenant may instantly show appropriate vendors based on the category and urgency. Maintenance requests may be quickly reviewed and assigned to a contractor/maintenance person based on the maintenance type and priority level which can be confirmed or changed by the landlord or authorized manager. Priority level may further refine the vendor list by vendor availability. Most urgent matters may produce vendor results to those who are most immediately available, and less urgent matters may be offered to vendors whose calendars are more open at later days of the week/month. A bidding aspect may be available for contractors to bid on posted jobs. Likewise, a bidding process or schedule in queue for a specific period may be initiated to reserve a vendor to inspect and/or perform the requested work. This process may alleviate phone intake and scheduling for landlords and vendors. Landlords can interview, schedule, review, invoice, pay, dispute/arbitrate, and more, through the management component in the landlord's portal.

Aspects relating to vendors, vendor management, and interaction by the vendors via an interface, for example a vendor dashboard, will now be discussed without limitation. From the available portals and interface aspects, vendors may easily manage the income/expenses, communication and maintenance requests, reporting, accounting, bookkeeping, tax accounting/reporting, invoicing/collections/disputes, marketing, constant contact, newsletters, promotions, ratings, reviews, and more from their portal. Vendors may set their availability, which may assist in determining eligibility and scheduling for maintenance requests with high urgency. Vendors may manage relationships with multiple landlords, tenants, agents, brokers, and other associations. Vendors may rate landlords, tenants, renters, agents, brokers, and other vendors. Likewise, landlords, tenants, renters, agents, brokers, and other vendors may rate a vendor. Ratings may be included on via distributed ledger. Additional discussions about vendors, vendor interaction with the system, and interaction by other parties with vendors is provided throughout this disclosure.

For the vendor, the landlord may easily select one or more vendors through the landlord management component. Vendors may be provided an option to accept or reject the maintenance performance invitation. Vendors can schedule, review, invoice, get paid, and dispute/arbitrate through the landlord management component.

The landlord-vendor management aspect will now be discussed. Vendors can subscribe to be on a vendor list to be hired by renters, landlords and/or authorized persons. This list may be included via a distributed ledger, without limitation. Landlords and/or property managers can assign vendors to answer routine or emergency maintenance requests, which can be initiated by renters, landlords, and/or authorized persons. This document may include features that may be included on a distributed ledger and may also include the use of smart contracts.

Landlords and/or authorized persons may easily review and respond to maintenance requests simply with the press of a button or the swipe on a touch screen.

While renters, landlords, and vendors interact, these participants may be rated on experiences that may affect respective member scores. Vendor services may also include escrow protection, which may advantageously reduce litigation, encourage cooperation, and increase efficiency and transparency. Vendors may use similar accounting features to manage their income and expenses as other parties.

The smart contract component will now be discussed in greater detail, without limitation. The smart contract component may be included as a platform component and/or provided independently of the other platform components. The smart contract component may advantageously assist with the creating, management, and execution of smart contracts. For example, the smart contract component may receive information from other components, an agent, landlord, renter, other end-user derived process/verification/system check, or external sources via an oracle. The system may analyze the contents of that information, compare the analysis to a condition in a smart contract, and execute an action based on the information if a condition is satisfied. Smart contracts associated with this disclosure may define rules, penalties, and distribution of resources between parties, and may substantially automatically enforce these aspects. Smart contracts may be used to set conditions and redefine conditions, allocate moneys, set rates, amounts, quantities, frequency of transactions and more.

The lead marketplace component will now be discussed in greater detail. FIGS. 1 and 3-16 highlight examples of the lead marketplace component, which may also be shown in other figures. The lead marketplace component may be operated to selectively transact the renter profile among agents and optionally landlords. The lead marketplace component may include a lead pool aspect, which may provide a marketplace for agents and landlords to buy leads from and sell leads to other agents, brokerages, teams, landlords, and/or authorized buyer. A renter lead marketplace may be provided for agent only, landlord only, agent and landlord, authorized buyers, and other combinations. For agent/managing broker/brokerage/team, the renter lead access may be designated to a hierarchy level, and/or designated functional group, team, staff, freelancer, employee, other users, for the purpose to also manage, transfer, buy, sell, trade, and assign originated, worked, and/or purchased leads. Leads may be transacted substantially automatically, for example, via a smart contract and/or in association with a distributed ledger.

The lead marketplace component may facilitate lead tracking. Transferred, sold, and assign leads may be sold for a fixed or otherwise definable amount with an agreement. Alternatively, a fixed or definable amount plus a percentage of gross commission income (GCI) may be used to benefit the originating agent. Tracking tools may be provided to inform the originating agent whether the renter competed the transaction, where the renter is in the process, or whether the renter signed a lease by giving limited visibility to the renter's case log. The limited access may show system registered activity including, but not limited to, system logs, last completed category, electronic communication, electronic transactions, uploads, documents, images, forms, activity logs, downloads, leases, notes, annotations, arbitration logs, and/or other designated information. When used with a decentralized system, access to information included by a distributed ledger may be provisioned manually, via smart contracts, or otherwise and provide additional transparency to account for efforts and money owed, paid, and/or transacted.

Rules may be established for selling and assigning leads. For example, an agent may be restricted from assigning leads that were assigned to the agent. However, the agent may be unrestricted from transacting the leads that agent purchased or originated. In another example, an agent may reject purchased and assigned leads. Rejecting and/or rating leads may establish lead quality. Rating purchased leads may contribute to the seller's rating and seller history. Rejections, ratings, and reviews may be used by the agent community. Once purchased, leads may be assigned to be serviced by staff and/or other agents in an agent's team hierarchy. Rules may be updatable and subject to change. Leads may be transacted using distributed ledgers and rules managed via smart contracts.

The lead marketplace component may include a renter lead marketplace for landlords. Landlords may collect dozens of renter applications for each rental listing while a unit is on the market. After a renter is selected for the rental property, the landlord will generally have other renter applicants who were not selected. Using the renter leads marketplace, the landlord can convert those extra applications into leads. These leads may be transacted using distributed ledgers, for example, via smart contracts. Landlords may sell leads to other landlords, agents, teams, brokerages, or other authorized buyers. The landlord may be required to provide proper disclosures to the renter during the application data gathering process, giving renter applicant notice that landlord may sell, trade, transfer renter data in the renter leads marketplace. Marketable leads may include renter information from the renter profile sufficient to decide who to allow to rent an available or upcoming real property unit.

Originated or purchased leads can be “worked” or built up to be more complete and closer to the lease signing stage. Once worked, the lead can be resold, potentially fetching a higher market value based on how much work was completed on that renter case to bring it closer to close. For example, provided without limitation, a renter lead that just started the process may only be worth $40, however after the agent, broker, or team helps the renter with document uploading and building the renter's profile, the lead may now be worth $160. The more marketable “worked” lead may now be sold to another agent who would only work on a lead with a substantially complete renter profile. Other stages of “worked” leads may be created without limitation and leads may be transacted using distributed ledgers, for example, via smart contracts.

The guaranteed rental income protection will now be discussed in greater detail. FIGS. 1 and 3-6 highlight examples of the guaranteed rental income protection, which may also be shown in other figures. Guaranteed rental income protection (GRIP) 116 may use actuarial science and weighing to determine risk associated with a renter. Information and/or transactions relating to GRIP may be includable in a distributed ledger, for example, as provided by a blockchain. In this example, information associated with GRIP may be included as data in a block, which may be included by a blockchain. New data regarding qualification, modification, transfer, assignment, leveraging, balance changing, deposit, withdrawal, claims, collateralizing, or otherwise interacting with GRIP may be added as an entry to the distributed ledger, as a block included by a blockchain, or otherwise stored in a distributed and/or at least partially decentralized destination.

GRIP may advantageously improve over traditional escrow protection vehicles. A renter with a sufficiently acceptable GRIP rating, which meets a threshold of eligibility for GRIP, may be eligible for assurances that tenant will pay rent in a timely manner. GRIP 116 may consider combined risk, landlord score, and/or renter score, tenant score, ratings, reviews, and other factors for an income property. The platform may determine whether to offer GRIP for eligible renters, tenants, and/or landlords and for what cost and coverage amounts, if any. GRIP may additionally include consideration for and/or affect deductible, terms, rules, policy, and exclusions/exceptions/limitations, if any.

The GRIP plan may protect the landlord's rental income against lease default, may cover some or all eviction, property damage costs, and may advantageously recover, reimburse, and/or pay some or all unpaid rent which results from renter lease default. GRIP coverage terms and conditions may be based on which packages the renter/tenant and/or landlord agree to purchase, their individual scores, and/or their combined scores. With GRIP, landlords can make decision to accept a renter quickly and with confidence, considering factors such as amount of pre-paid rent, security deposit, escrow, guarantees, fees, or otherwise. In at least one embodiment, GRIP may enable landlords to make decisions to accept a renter quickly and with confidence, considering factors such as amount of pre-paid rent, security deposit, escrow, guarantees, fees, or otherwise without exception.

GRIP may be affiliated with lending products. Once a landlord's renter occupancy percentage in a building achieves a certain GRIP subscription saturation, the platform may be able to leverage this income security to help the landlord obtain better financing terms on their mortgage or another line of credit. A lending platform and/or syndicated lending products may offer landlords access to more financing options with better terms, so landlords can finance, refinance, obtain credit cards and other financial instruments at lower rates and/or repayment options. The lending platform may advantageously provide commercial lending options in as large a variety and flexibility as those offered to residential home buyers or more. GRIP may also be leveraged to obtain pre-approval for rent-to-own, seller financing and other renting/financing options, including those for roommates. GRIP may also leverage employer's cooperation or involvement to assist a renter or buyer with qualifying for GRIP by agreeing to honor agreements such as wage assignment or demand draft.

GRIP plans may include a purchase option. A GRIP pre-approval letter may be conditional on its issuance to approved landlords. A standalone GRIP letter can be issued with restrictions if an approved landlord is not linked to or is not otherwise participating with the GRIP approved renter/tenant. Renter applicants may choose a GRIP approved landlord and/or suggest a landlord to be reviewed for GRIP approval. GRIP plans may come with a coverage period, coverage amount, upfront, ongoing, and/or per event cost(s), inclusions, exclusions, claim instructions, and/or general instructions, conditions, and terms. Tenant and/or landlord may also apply to purchase a GRIP plan during an active lease period. In at least one embodiment, this information may be provided via a distributed ledger.

In the event of lease default, a loss may be claimed against GRIP, and may be reviewed to determine claim eligibility. Claim eligibility may consider landlord's commitment to specific guidelines under terms of service, terms of lease, tenant's rights, quality of maintenance and condition of real property unit and real property building. Claim eligibility may consider renter's commitment to honor lease and tenancy terms, if any. Claim disbursements may cover at least some of the unpaid rent, property damage, cost for special or regular process server, court filing, and/or attorney's fees in varying coverage portions based on eligibility and GRIP terms of service. Mediation may be offered or required to resolve disputes without legal action. If resolution is not reached, legal action may be necessary. An agreed cost of legal action, arbitration, or mediation activities by may be covered by GRIP. Additionally, rights to find a replacement tenant to mitigate company's and/or landlord's income loss may also be included in GRIP. Repairs to damage caused by a renter may be a necessary element to bring a real property unit to rentable condition may be partially or entirely covered by GRIP. Deductible, security deposit, collected premiums, garnishment and judgements against the defendant, if any, may be used to offset GRIP costs. Some of these features and more may be included in a customizable GRIP package. GRIP claims may be surrogated, and plans may be underwritten and/or factored. One or more of the decisions associated with GRIP may be included in a smart contract and/or may be performed using a decentralized autonomous organization.

GRIP lending products may be provided. Real estate investment trust (REIT) companies may also benefit from using income protection to create added security for the investors who invest in REIT asset portfolios. Income protected investments may provide a competitive advantage to REITs as compared to REITs that do not use it to protect their assets and clients. GRIP may be provided as a financial product including for factoring receivables and using other liability mitigation techniques. GRIP may be factored, selling this receivable/liability at a discount for immediate cash infusion to offset future liability. GRIP may also be bundled and sold as a bond or some other long-term or short-term security to manage risk, asset-to-liability ratios, and hedge against economic or political risk. Experience charts may be used to establish guaranteed rental income protection (GRIP) values to protect some or all the landlord's rental income, for a determinable duration and plan cost. Experience charts may be used to determine lease default probability. GRIP may be offered to only qualified tenants with financial stability, those who operate within defined rules, and/or meet defined thresholds for eligibility. GRIP may be offered in the form of a card, certificate, policy, and/or other instrument. GRIP may be a financial instrument that can be bought, sold, transferred, traded, collateralized, leveraged, factored, packaged and/or derivatized.

The renter profile validation aspect, which may additional include sharing features, will now be discussed in greater detail. FIGS. 1 and 3-6 highlight examples of the renter profile validation aspect, which may also be shown in other figures. The renter component may further include a renter profile validation aspect to receive documentation that is intended to validate at least part of the renter information included by the renter profile. The renter profile validation aspect may communicatively cooperate with the matching component, broker-assisted component, and/or landlord direct component to compare renter-supplied information with the information included in evidence including uploaded documents, indirectly-sourced data, and third-party data sources. This information may be included in and provided by a distributed ledger, such as a blockchain. External information may be included in the distributed ledger via an oracle. The renter information determined not to be valid may be selectively purged from the renter profile. The renter/tenant score may be adjusted for false information about the renter/tenant.

The tenant exchange will now be discussed in greater detail. FIG. 1 highlights examples of the tenant exchange, which may also be shown in other figures. The tenant exchange 118 may provide a marketplace to transact rights to rental income from tenants. The tenant exchange 118 may include a renter's auction, which may allow renter scores and landlord scores to be considered to match renters and landlords together based on their scores. Score rated members may have the option to “opt in” and participate in being instantly matched via the tenant exchange 118, by an initiating party, system, electronic registry, renter/tenant, or landlord. Like the stock exchange, renters/tenants and landlord may bid or engage in a transactional relationship using “virtual calls and puts” via the online tenant exchange 118. This novel exchange advantageously provides a significant competitive advantage to renters living in cities where renting is highly competitive. Renters can bid against each other to rent from a landlord, tenant, or lease holder; and lease holders/landlords may bid against each other to attract a tenant. Similarly, renter groups can bid to purchase real property and landlord groups can bid to purchase real property. Tenant/renter groups and landlord groups can bid against each other or work together to purchase real property or otherwise engage in crowdfunding.

The tenant exchange may allow renters to barter, sell, and/or exchange property rights they have in a lease with other tenants or renters interested in buying, using, leasing, exchanging property rights. Some renters may participate in a tenant exchange to be substantially automatically matched, such as by leveraging renter scores, GRIP, and/or blockchain with/without smart contracts, with current or upcoming vacancy to gain an advantage to be accepted to rent a real property unit. This tenant exchange may be most advantageously utilized in a hyper-competitive rental market. Information may be brokered in an open market, such as with a stock exchange, sold to, purchased, leveraged, hedged, optioned, and otherwise transacted by a buyer, renter, tenant, agent, landlord, and/or other party.

Referring now to FIG. 2, an illustrative computerized device will be discussed, without limitation. In some embodiments, such an illustrative computerized device may be used as a node in a distributed network. Various aspects and functions described in accord with the present disclosure may be implemented as hardware or software on one or more illustrative computerized devices 200 or other computerized devices. There are many examples of illustrative computerized devices 200 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 200 may include mobile computing devices, cellular phones, smartphones, tablets, video game devices, personal digital assistants, network equipment, devices involved in commerce such as point of sale equipment and systems, such as handheld scanners, magnetic stripe readers, barcode scanners and their associated illustrative computerized device 200, among others. Additionally, aspects in accord with the present disclosure may be located on a single illustrative computerized device 200 or may be distributed among one or more illustrative computerized devices 200 connected to one or more communication networks. Smart software may be included that can be used to read text and/or images uploaded by users.

For example, various aspects and functions may be distributed among one or more illustrative computerized devices 200 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any distributed architecture, network, or communication protocol.

FIG. 2 shows a block diagram of an illustrative computerized device 200, in which various aspects and functions in accord with the present disclosure may be practiced. The illustrative computerized device 200 may include one or more illustrative computerized devices 200. The illustrative computerized devices 200 included by the illustrative computerized device may be interconnected by, and may exchange data through, a communication network 208. Data may be communicated via the illustrative computerized device using a wireless and/or wired network connection.

Network 208 may include any communication network through which illustrative computerized devices 200 may exchange data. To exchange data via network 208, systems and/or components of the illustrative computerized device 200 and the network 208 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 200 may transmit data via the network 208 using a variety of security measures including TSL, SSL, SFTP, SSH, or VPN, among other security techniques, for example, through a web application firewall to protect user data against virus and malware. The illustrative computerized device 200 may include any number of illustrative computerized devices 200 and/or components, which may be networked using practically any medium and communication protocol or combination of protocols.

Various aspects and functions in accord with the present disclosure may be implemented as specialized hardware or software executing in one or more illustrative computerized devices 200, including an illustrative computerized device 200 shown in FIG. 2. As depicted, the illustrative computerized device 200 may include a processor 210, memory 212, a bus 214 or other internal communication system, an input/output (I/O) interface 216, a storage system 218, and/or a network communication device 220.

Additional devices 222 may be selectively connected to the computerized device via the bus 214. Processor 210, which may include one or more microprocessors or other types of controllers, can perform a series of instructions that result in manipulated data. Processor 210 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 210 may be connected to other system elements, including a memory 212, by bus 214.

The illustrative computerized device 200 may also include a network communication device 220. The network communication device 220 may receive data from other components of the computerized device to be communicated with servers 232, databases 234, smart phones 236, and/or other computerized devices 238 via a network 208. Additional devices may be connected via the network, for example, blockchain miner(s) 242 that may contribute processing power to authenticate data and/or transactions associated with a distributed ledger. The communication of data may optionally be performed wirelessly. More specifically, without limitation, the network communication device 220 may communicate and relay information from one or more components of the illustrative computerized device 200, or other devices and/or components connected to the computerized device 200, to additional connected devices 232, 234, 236, and/or 238. Connected devices are intended to include, without limitation, data servers, additional computerized devices, mobile computing devices, smart phones, tablet computers, and other electronic devices that may communicate digitally with another device. In one example, the illustrative computerized device 200 may be used as a server to analyze and communicate data between connected devices.

The illustrative computerized device 200 may communicate with one or more connected devices via a communications network 208. The computerized device 200 may communicate over the network 208 by using its network communication device 220. More specifically, the network communication device 220 of the computerized device 200 may communicate with the network communication devices or network controllers of the connected devices. The network 208 may be, for example, the internet. As another example, the network 208 may be a WLAN. However, skilled artisans will appreciate additional networks to be included within the scope of this disclosure, such as intranets, local area networks, wide area networks, peer-to-peer networks, and various other network formats. Additionally, the illustrative computerized device 200 and/or connected devices 232, 234, 236, and/or 238 may communicate over the network 208 via a wired, wireless, or other connection, without limitation.

Memory 212 may be used for storing programs and/or data during operation of the illustrative computerized device 200. Thus, memory 212 may be a relatively high performance, volatile, random access memory such as a dynamic random access memory (DRAM) or static memory (SRAM). However, memory 212 may include any device for storing data, such as a disk drive or other non-volatile storage device. Various embodiments in accord with the present disclosure can organize memory 212 into particularized and, in some cases, unique structures to perform the aspects and functions of this disclosure.

Components of illustrative computerized device 200 may be coupled by an interconnection element such as bus 214. Bus 214 may include one or more physical busses (for example, busses between components that are integrated within a same machine), but may include any communication coupling between system elements including specialized or standard computing bus technologies such as USB, Thunderbolt, SATA, FireWire, IDE, SCSI, PCI and InfiniBand. Thus, bus 214 may enable communications (for example, data and instructions) to be exchanged between system components of the illustrative computerized device 200.

The illustrative computerized device 200 also may include one or more interface devices 216 such as input devices, output devices and combination input/output devices. Interface devices 216 may receive input or provide output. More particularly, output devices may render information for external presentation. Input devices may accept information from external sources. Examples of interface devices include, among others, keyboards, barcode scanners, mouse devices, trackballs, magnetic strip readers, microphones, touch screens, printing devices, display screens, speakers, network interface cards, etc. The interface devices 216 allow the illustrative computerized device 200 to exchange information and communicate with external entities, such as users and other systems.

Storage system 218 may include a computer readable and writeable nonvolatile storage medium in which instructions can be stored that define a program to be executed by the processor. Storage system 218 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, for example, be optical disk, magnetic disk or flash memory, among others. In operation, processor 210 or some other controller may cause data to be read from the nonvolatile recording medium into another memory, such as the memory 212, that allows for faster access to the information by the processor than does the storage medium included in the storage system 218. The memory may be located in storage system 218 or in memory 212. Processor 210 may manipulate the data within memory 212, and then copy the data to the medium associated with the storage system 218 after processing is completed. A variety of components may manage data movement between the medium and integrated circuit memory element and does not limit the disclosure. Further, the disclosure is not limited to a particular memory system or storage system.

Although the above described illustrative computerized device is shown by way of example as one type of illustrative computerized device upon which various aspects and functions in accord with the present disclosure may be practiced, aspects of the disclosure are not limited to being implemented on the illustrative computerized device 200 as shown in FIG. 2. Various aspects and functions in accord with the present disclosure may be practiced on one or more computers having additional components than that shown in FIG. 2. For instance, the illustrative computerized device 200 may include specially-programmed, special-purpose hardware, such as for example, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 200 may include an operating system that manages at least a portion of the hardware elements included in illustrative computerized device 200. A processor or controller, such as processor 210, may execute an operating system which may be, among others, an operating system, one of the above mentioned operating systems, one of many Linux-based operating system distributions, a UNIX operating system, or another operating system that would be apparent to skilled artisans. Many other operating systems may be used, and embodiments are not limited to any particular operating system.

The processor and operating system may work together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present disclosure may be implemented using an object-oriented programming language, such as JAVA, C, C++, C#, Python, PHP and PHP-based platforms like CakePHP or Codeigniter, other platforms such as Laravel, AugularJS variants, Node.JS, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (for example, documents created in HTML5, HTML, XML, CSS, JavaScript, or other format that, when viewed in a window of a browser program, render aspects of a graphical-user interface or perform other functions). Additionally, various aspects of this disclosure may be developed for mobile devices, implemented in Bootstrap HTML/HTML5, iOS, C, C++, NDK, C#, as well as cross platform languages such as PhoneGap or Ionic. Ajax may be one of the techniques used on the client side interface to create asynchronous web applications. Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, for example, Database Management Systems such as a SQL Server available from Microsoft of Redmond, Wash., Oracle Database or MySQL from Oracle of Redwood City, Calif., or integration software such as phpMyAdmin, WebSphere middleware from IBM of Armonk, N.Y.

In operation, a method may be provided for facilitating, matching, engaging, contracting, and communicating between parties to a real estate and/or property rental transaction by a system that may be network-leveraged and/or decentralized. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

Illustrative agent/broker operations will now be discussed, without limitation. Agents, brokers, and other transaction facilitators may interact with the platform according to their role. A user can sign up as an advertiser, landlord aggregator, agent, or managing broker or office and then develop their role to transition into another role. Roles may be changed and/or expanded. Roles may be recorded to a distributed ledger. Other support roles may also be provided, as will be appreciated by those of skill in the art after having the benefit of this disclosure.

Once the agent, managing broker, and/or brokerage office is registered they can manage their dashboard and perform tasks such as managing and transacting leads, managing renter applicants, calendar appointments, property listings, property data, landlord data, rental data, property map, CMS and all of the features involved in the CMS including newsletter creating and cron scheduling and various agent created and system provided forms and templates, inbox messages, searching/managing the landlord database, managing financials, stats, open agreements, team plans, reporting, contact information, contract terms and conditions, their local and virtual teams, and more. Managing renter applicants may include the review of a renter profile including renter risk, renters score, screening questionnaires, electronic forms, uploaded documents, application, requests, communication with renters, tenants, landlord, other agents, teams, long and short message communication, matching renters to available properties, financial/GRIP accounting, and document verification. Leads can be bought, sold, traded, transferred, and managed through the lead pool system. Staff activity can be tracked and monitored using built in statistics charts and queries. Virtual teams can be associated to and disassociated from the other team hierarchies and the hierarchy diagram may be visible through the team dashboard.

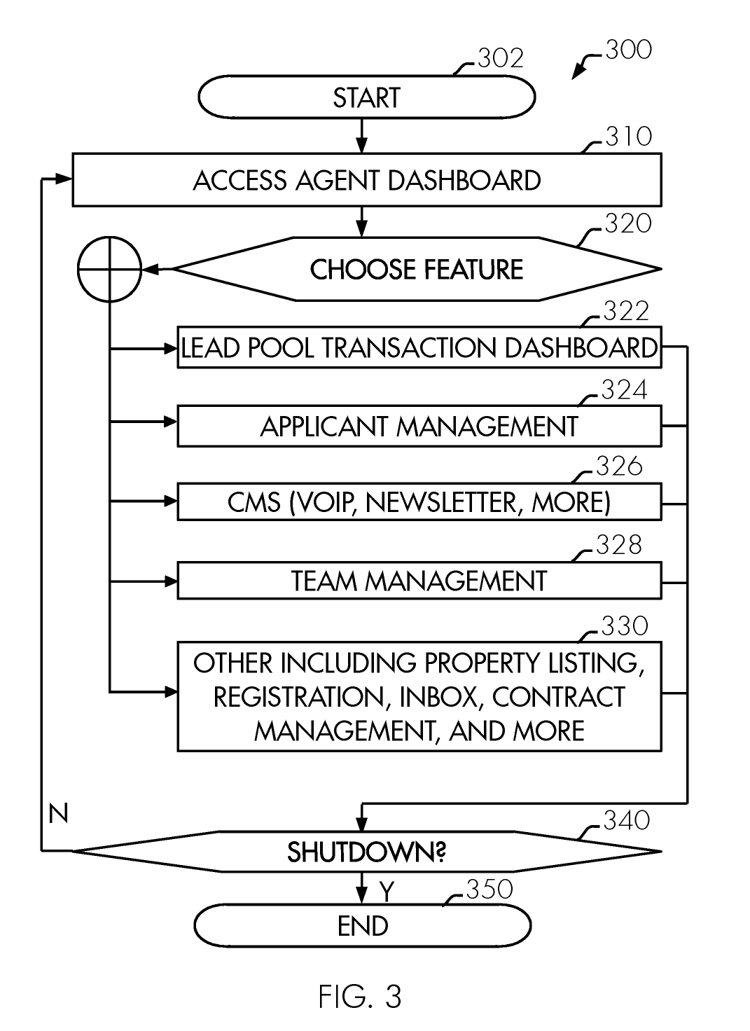

Referring now to flowchart 300 of FIG. 3, an illustrative method for an agent management operation will be described, without limitation. Starting with block 302, the operation may begin by an agent accessing their agent dashboard. (Block 310). If the agent does not yet have an agent profile, they may be offered to create one. Use of the term agent may include functions that are also available in the managing broker or brokerage dashboard.

The agent may then choose a desired feature. (Block 320). If the agent desires to manage and transact leads, the agent may access the lead pool transaction dashboard and also the payment account management dashboard so that agent may add/withdraw money. (Block 322). Here, the agent may view and manage apartment listings, so advertising teams can post advertisements with photos and unit details, for example. If the agent desires to manage applicants and their respective applications, the agent may access the applicant management feature. (Block 324). Here, the agent may interact with risk/cost summaries, screening questionnaires, uploaded documents, forms, messages, matching properties, and accounting features. For example, if the agent wants to see top rated applicants for a given listing, agent can go to Property Listings menu from the dashboard.

If the agent desires to manage CMS to view and schedule a real property viewing, see business hours, access a record, or make calls, the agent may access the CMS feature set. (Block 326). This information may be provided by a distributed ledger. The CMS feature set may include, but is not limited to, purchase number VOIP account connection to agent account, auto-responder content, cron settings for various follow-up tasks, first contact and other trigger event, or other fully/partially/substantially-automated features which are used to send in-app, email, phone, social media, blog and other communication for/to renter, tenant, landlord, local/virtual team, agent, broker, brokerage. These events may be associated with a smart contract. If the agent desires to manage their team, the agent may access the team management feature. (Block 328). If the agent desires to find a new managing broker or brokerages, join new hierarchy or expand agent's hierarchy branch, the agent can access the Team feature. If the agent desires to engage another feature, such as a calendar, property listings, registration process, map, inbox, contract management, new landlord record creation, manage landlord data, manage renter/landlord hotlist, active list, pending action list, CMS, profile builder, or other feature, the agent may access that feature or any future that may be later added or expanded. (Block 330). The profile builder may include a tool to substantially automate the creation of a renter profile to assist agent with presenting the renter profile to a landlord. Inclusion of a profile builder tool may advantageously require less time and effort while providing increased accuracy in renter information associated with the renter profile, increasing the likelihood of a successful outcome for a renter/tenant who engaged agent for such services. In one embodiment, this tool may include a smart contract and/or may be operated by a decentralized autonomous organization, such as may be provided with the platform components.

The agent may then determine whether to terminate their session at block 340. If it is determined at block 340 not to terminate the session, the agent may then be redirected to again access the agent dashboard at block 310 if the session is not automatically expired. If it is determined at block 340 to terminate the session, the operation may end at block 350 and notice of eminent session termination may be declared to agent.

Illustrative features of an example interface will now be discussed, without limitation. The interface may include multiple pages accessible by a user. For example, the interface may include account page with a dashboard featuring communication tools, analytic tools, calendaring tools, and other tools to facilitate matching a renter with a landlord. For example, a dashboard portion may include a calendar page, which may be expandable when interacted with, such as using an accordion style, without limitation. Calendaring features of this illustrative dashboard will be discussed in greater detail below. The dashboard may additionally include a sales trend page, which may give a visual and data representation of sales performance metrics.

The dashboard may also include a sales funnel, which may visualize performance metrics. The sales funnel may include multiple stages in the matching process, for example accessing a landing page by a renter (1)>renters invited to interact with the dashboard (2)>renters scheduled to interact with a landlord (3)>renters signed up to with a landlord (4)>and renters with closed matchings (5). The sales funnel may provide a visual indication of performance between each stage, which may indicate a drop-off from each stage in sales funnel.

The dashboard may include an inbox, which may also include additional communication categories. The inbox may include user reviews, a pre-fasttrack feature indicative of a renter that has communicated but has not yet created an account, a partial fasttrack feature indicative of a renter that filed out some information to register but didn't submit, a texting and SMS interface, a long message interface such as internal email, follow-up messages, and customer reminders that may be set internally by the team.

The dashboard may include an applicant management feature, which may provide and organize contact information, lead pool information, timeline information, system logs, and/or other information. Notification information may be provided with a brief intro to a long message that could be sent to another party. The dashboard may include search criteria, such as basic search criteria. Renters and other users in the process may search by categories, folder categories, rate renters, and otherwise perform searches.

The dashboard may include a money section, through which a user may transact leads, manage financials, and otherwise manage the money aspects of a real estate or other transaction. The dashboard may include a property listings menu, through which a user may see active listings, rented listings, and other listings. For example, users may view images of active listings, show property data, view sets such as a top 5 or other number of renters for each listing. The dashboard may include a team section, through which a user may look at local and/or virtual teams. Through the team section, the user may view and/or manage advertisers, agents and hierarchies, rental marketing, office staff, and others. The dashboard may include a dialer features, through which a user may call from the interface.

The dashboard may include an account section, which may allow the viewing and/or modification of personal information about a user, credentials, appointment notifications, schedule availability, view of statistics, pivot table, fasttrack surveys, and/or other data. The dashboard may additionally include CMS menus, which may provide access to features such as templates, automated messages, GRIP, e-forms, newsletters, and other features. Users may schedule messages, create and manage newsletters, manage unsubscribe settings for newsletters

The dashboard may include an interface to manage applicants, record views and related details, and otherwise interact with an applicant. The applicant management interface may allow a user to record view, view details about a unit, view a risk/cost to rent, view fasttrack info, view screening information, manage appointments, access e-forms, engage options to reactivate an application form, view uploaded documents, view messages associated with applicant, view logs, check compensation earned by people working on the application, view matches, keep notes for timeline, see in chronological order what kind of work has been done, schedule to folders, and otherwise interact with the interface.

Through the applicant management features, a user may also click on a property to view and/or manage details relating to the property. For example, the user may review landlords, substantially automatically send an opt-in to a landlord, allow a landlord to opt-in to do advertising, send a landlord a text message to opt-in, send a copy of opted-in landlord details to an agent and/or managing broker, and other features. A managing broker may accept or sign-off on a landlord and/or unit to be listed. The information may then be sent to an advertising team and/or be shared with agents to start marketing the unit. Offer details may auto-populate for a listing.

The dashboard may include one or more reports, for example, regarding an integration of a pipeline. Users may manage workflow for renters and/or landlords. For managing renters, the use may select a category, determine a category section, and filter information by criteria such as rank or urgency. For example, rank may be filtered by a status in the rental process, including initially performing a search, in a time-sensitive window (for example, within a 7-day deadline), being provided a second chance offer, having a landlord offer but waiting on a renter, being a motivated renter engaging with a landlord, having a paid rental transaction and agreement, inactive, or otherwise categorized. The categories may be color-coded to help a user quickly determine the status of a renter, application, or other source of information. Quick statistics may be provided, for example, customer name, price max, number of bedrooms desired, number of bathrooms desired, pets, search criteria, renter summary including positive and marks, and other statistics that would be appreciated by a person of skill in the art after having the benefit of this disclosure. The renter summary may be auto populated by system by information renters provided and can include a renter score. The pipeline integration may include a hot list of renters that already completed all their documents and are now in the process of getting offers and matches.

The dashboard may include agent team management features. For example, a user may manage calendars of associated teams. Calendar management may include controlling availability requests, time off requests, office hours, blocked off time, hours of operation, and other calendaring features that will be apparent after having the benefit of this disclosure. Calendared periods may be managed one-time, hourly, daily, weekly, monthly, dynamically, periodically, or otherwise, without limitation.

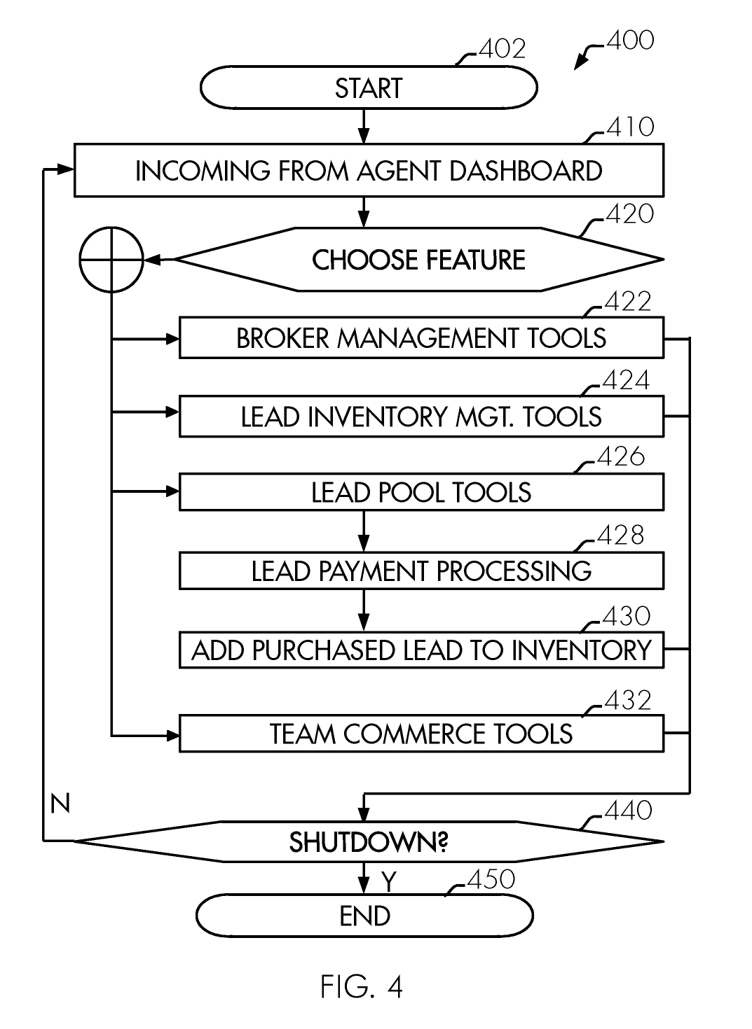

Referring now to flowchart 400 of FIG. 4, an illustrative method for a lead pool transaction aspect of the agent management operation will be described, without limitation. Starting with block 402, the operation may begin by the agent incoming from the agent dashboard. (Block 410). This step may include substantially all agent dashboard features.

The agent may then choose a desired feature. (Block 420). If it is determined at block 420 that the agent desires to interact with broker management tools, the agent may be directed to the broker management tools feature to monitor and manage agent activity, including adding and removing agents. (Block 422). The broker management tools of this step may include association/disassociation. If it is determined at block 420 that the agent desires to interact with the lead inventory, the agent may be directed to the lead inventory management tools and features to view open, selling or sold leads. (Block 424). If it is determined at block 420 that the agent desires to interact with lead pool tools, the agent may be directed to the lead pool tools to buy, sell, trade, and otherwise transact leads from the lead pool. (Block 426). In one example, lead pool trading may occur where many less expensive leads can be traded for fewer expensive leads. Information about leads may be provided via a distributed ledger. Transactions involving leads may be performed using smart contracts and may be performed by a decentralized autonomous organization.

From block 426, the agent may indicate a lead that they wish to purchase and proceed to payment processing. (Block 428). After the lead is purchased, the lead may be added to the agent's lead inventory. (Block 430). These added leads may then be assigned, sold, rejected, completed, or traded. These transactions may be performed using smart contracts, for example, via the smart contract component.

If it is determined at block 420 that the agent desires to engage with team commerce features, including the creation of local and/or virtual teams, the agent may be directed to the team commerce tools and features. (Block 432). Using the team commerce tools, the agent may define teams that can operate locally/virtually, establish a team hierarchy, manage broker/agent relations, manage team hierarchies, associate/disassociate team participants, and otherwise manage a team.

Incoming from blocks 422, 424, 430, or 432, the agent may then determine whether to terminate their session at block 440. If it is determined at block 440 not to terminate the session, the agent may then be redirected to the incoming state from the agent dashboard at block 410. If it is determined at block 440 to terminate the session, the operation may end at block 450.

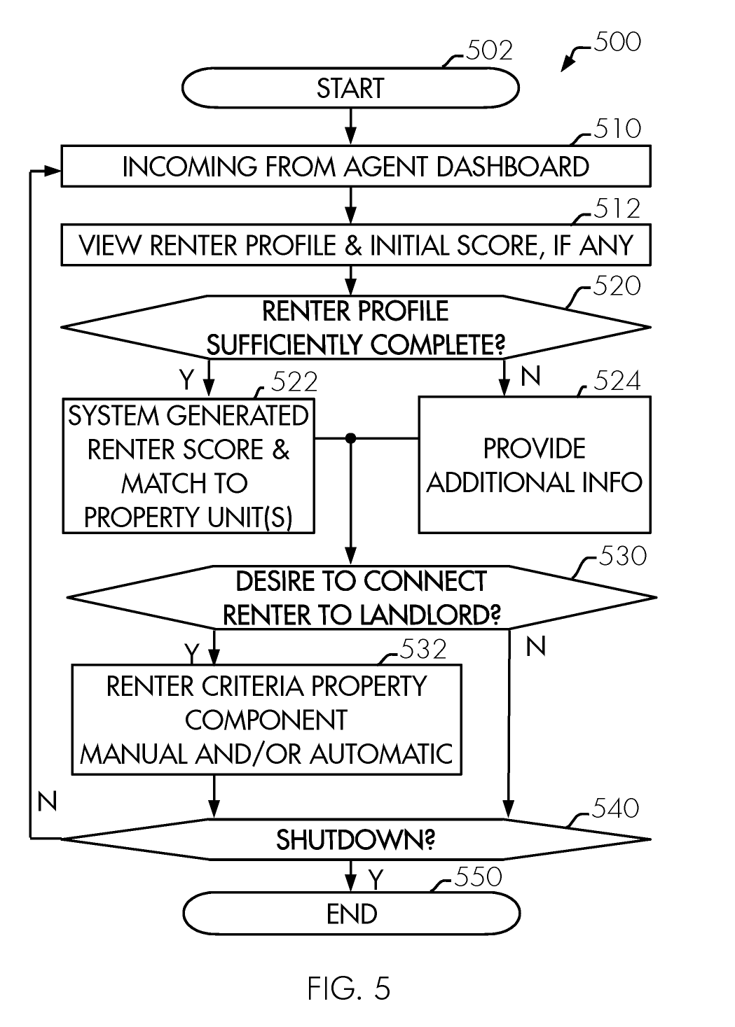

Referring now to flowchart 500 of FIG. 5, an illustrative method for an applicant management aspect of the agent management operation will be described, without limitation. Starting with block 502, the operation may begin by the agent incoming from the agent dashboard. (Block 510). The agent may then view a renter profile, which may include an initial score. (Block 512).

It may then be determined if the renter profile is sufficiently complete. (Block 520). If it is determined at block 520 that the renter profile is sufficiently complete, the operation may generate a renter score and match the score to one or more property units. (Block 522). If it is determined at block 520 that the renter profile is not sufficiently complete, the operation may request the additional information for the renter profile. (Block 524).

From the steps of blocks 522 or 524, the operation may determine whether it is desired to connect the renter with a landlord, which may help match real property units with a renter. (Block 530). If it is determined that it is desired to match real property units with a renter at block 530, the operation may search for real property units to match with the renter. (Block 532). Information about units and/or requirements and conditions for those units may be include in a distributed ledger. Units suitable for matching may be included in a renter criterial property matching component, which may facilitate matching a landlord with an applicant by, for example, requiring a matching threshold indicating a likelihood of compatibility. Renter may also modify the search criteria to access search results which are different from those that may be produced from those generated by the auto-criteria search. In this example, a renter may include any user who is searching for new tenancy and may or may not be a tenant of another real property unit at the time of the search. A renter may search for landlords, property, and units by star rating and/or by score.

After the operation of block 532, or if it is determined at block 530 that it is not desired to match real property units, the agent may determine whether to terminate their session at block 540. If it is determined at block 540 not to terminate the session, the agent may then be redirected to the incoming state from the agent dashboard at block 510. If it is determined at block 540 to terminate the session, the operation may end at block 550.

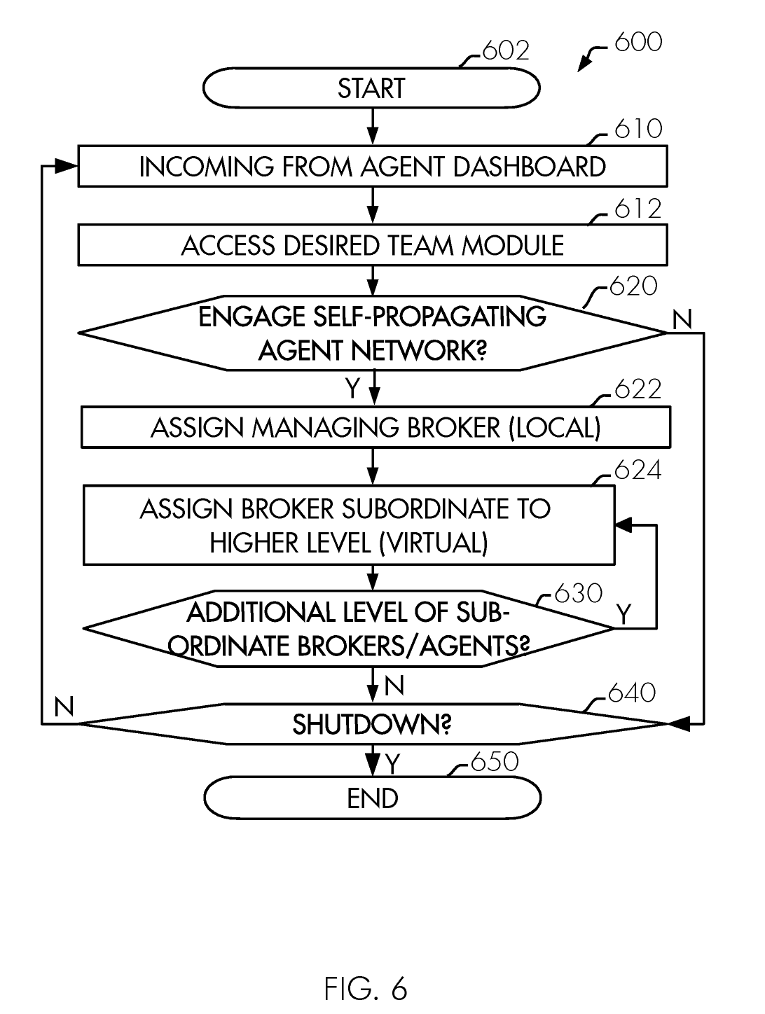

Referring now to flowchart 600 of FIG. 6, an illustrative method for a team management aspect of the agent management operation will be described, without limitation. Starting with block 602, the operation may begin by the agent incoming from the agent dashboard. (Block 610). The agent may then access the desired team module. (Block 612).

It may then be determined if the agent wishes to engage the self-propagating agent network. (Block 620). If it is determined at block 620 that the agent wishes to engage the self-propagating network, the operation may be initiated by the agent by requesting to join a team, become a child or subordinate in that agent's hierarchy, or accept a request to a parent/leader to an agent or agent's team. (Block 622). This may be performed locally and/or virtually. The operation may then assign one or more brokers that are subordinate to another broker to a next higher level of hierarchy. (Block 624). This operation may be performed virtually. Subordinates may be arranged in a competitive and/or cooperative relationship.

It may then be determined whether an additional level of subordinate brokers is desired. (Block 630). If the relationship is virtual, the subordinates may be managing brokers/agents. If the relationship is local, the subordinates may include agents only. If it is determined at block 630 that an additional level of subordinate brokers is desired, the operation may return to block 624 and assign brokers subordinate to the last assigned level.

If it is determined at block 620 not to engage in a self-propagating agent network, or if it is determined at block 630 not to define an additional level of subordinate brokers, the operation may then determine whether to terminate the session at block 640. If it is determined at block 640 not to terminate the session, the agent may then be redirected to again access the desired team module at block 612. If it is determined at block 640 to terminate the session, the operation may end at block 650.

Illustrative landlord operations will now be discussed, without limitation. The landlord may have several options for onboarding. The landlord may be invited from a listing process, may visit the website, may be invited by an agent/broker/team/agency/renter/vendor to join. The landlord may be invited by a renter to view the renter's profile or in a broker-assisted process, the landlord may be invited by the renter's assisting agent to view the renter's profile. To view renter profiles, invites may be made with a temporary access token. If the landlord is not registered, the temporary token can give landlord time to view the profile and decide whether to move forward. The landlord may join from this point by registering from the landlord's temporary access dashboard. Landlord may also register directly from the platform to claim an existing landlord, property, rental unit, or other record or create new records. The landlord may also respond to a text message auto-reply which the landlord would receive by calling or texting an information number from an advertisement. The landlord may also scan a barcode or QR code on an advertisement or respond to a link which will direct landlord to sign-up. Vendors, agents, managing brokers, brokerages, and/or contractors may also be invited in the manner described above. The landlord may review rental applications that have come in or invite renter applicants. The landlord can also manage listings, create, edit, delete property and vacant units, answer maintenance request, and review renters. The renter may negotiate and sign a lease through the same portal. The landlord may hire teams to do maintenance, advertise, and delegate bookkeeping through the site, which may be tracked, recorded, documented, and includable on a distributed ledger, for example, as may be provided via a blockchain.

Once logged in, the landlord may access a dashboard to invite and view renter profiles. The landlord may decide whether to rent to applicants. The landlord may also purchase, or require renters purchase, GRIP. The landlord may sell renter leads that the landlord did not accept for tenancy. If the landlord chooses to go through the landlord direct component, the landlord can sign up or login to manage properties and finances through built-in property management platform components. The landlord may invite a registered vendor or send an invite to a non-registered vendor, for example, directly from a landlord's dashboard with the purpose of hiring vendor to assist landlord or landlord can invite vendor with the incentive of getting compensated for any vendor who signs up and remains/performs in the system for some minimum threshold. At least some of these interactions may be tracked by the system and includable on a distributed ledger, for example, as may be provided via a blockchain.

Referring now to flowchart 700 of FIG. 7, an illustrative method for a landlord direct operation will be described, without limitation. Starting with block 702, the operation may begin by a landlord logging in (Block 710). If the landlord does not have login credentials, they may be given the opportunity to sign up.

It may then be determined if the landlord desires to manage availability of their units. (Block 720). If it is determined at block 720 that the landlord desired to manage the availability of their units, the landlord may claim properties and provide related information. (Block 722). The landlord may toggle rental unit availability to receive applications from renters for the available units. (Block 724). These details may be associated with information in a distribute ledger.

From block 724, or if block 720 was decided in the negative, it may be determined if a rental application is available. (Block 730). If it is determined at block 730 that rental applications are available, the landlord may receive an authorization token from the renter to view the renter profile associated with the application. (Block 732). The landlord may then view the application and/or renter profile. (Block 734).

It may then be determined if the landlord will accept the renter. (Block 740). If it is determined at block 740 that the landlord will accept the renter, the parties may formalize the transactional relationship, for example, by signing a lease. (Block 742). Formalizing of the transactional relationship may also include negotiation of terms to be included by the transactional relationship, for example, in a lease. If it is determined at block 740 that the landlord will not accept the renter, the landlord may be given an opportunity to sell the lead to another landlord, agent, or entity. (Block 744).

From blocks 742 or 744, or if block 730 is decided in the negative, the landlord may then determine whether to terminate their session at block 750. If it is determined at block 750 not to terminate the session, the landlord may then be redirected to again determine whether to manage the availability of their units at block 720. If it is determined at block 750 to terminate the session, the operation may end at block 760.

Referring now to flowchart 800 of FIG. 8, an illustrative method for a landlord management operation will be described, without limitation. In some embodiments, the landlord may also have some of the same features as the agent, including CMS, team, and other features discussed along with FIG. 3 and throughout this disclosure. Starting with block 802, the operation may begin by the landlord logging in to the platform. (Block 810). If the landlord does not have login credentials, they may be given the opportunity to sign up. The landlord may then access the landlord dashboard. (Block 812).

It may then be determined whether to search for renters for an available unit. (Block 820). If block 820 is decided in the affirmative, the landlord may be sent to the landlord direct component or broker-assisted component. (Block 822). The selected component may depend on which is chosen, and a landlord may choose to use either or both components at any time, however, some restrictions may apply. Search may also be made by establishing search criteria which may include combined household income, total number of occupants, pets allowed, credit/star/risk/GRIP as desired, percentage of profile completion, and/or other criteria as permissible by law. Search criteria may reference profile data created by renters and/or the system.

From block 822, or if block 820 was decided in the negative, it may then be determined whether to view available messages. (Block 830). If block 830 is decided in the affirmative, the landlord may interact with the communication component to access an inbox and communicate with other parties. (Block 832).

From block 832, or if block 830 was decided in the negative, it may then be determined whether to manage finances. (Block 840). If block 840 is decided in the affirmative, the landlord may interact with the landlord financial aspect of the landlord management component. (Block 842). Here, the landlord may manage income, view rental income and expenses, and otherwise manage finances as discussed throughout this disclosure.

From block 842, or if block 840 was decided in the negative, it may then be determined whether to manage maintenance requests. (Block 850). If block 850 is decided in the affirmative, the landlord may be sent to the maintenance request aspect of the landlord management component. (Block 852). Here, the landlord may view requests from a maintenance inbox. The landlord may also view renter profiles associated with the requesting tenant and create a rating and review, which may be optionally be included in a distributed ledger.

From block 852, or if block 850 was decided in the negative, it may then be determined whether to access other features, such as reviewing of applications, management of listings, or other features. (Block 860). If block 860 is decided in the affirmative, the landlord may be sent to the aspect or feature related to the desired operation. (Block 862). Features and aspects of this disclosure that could be included for interaction at block 862 may include, but should not be limited to, a renter's marketplace, renter community social network, tenant community social network, management of a transactional relationship, reviews, ratings, communications, and other features that will be apparent to a person of skill in the art after having the benefit of this disclosure.

From block 862, or if block 860 was decided in the negative, the landlord may then determine whether to terminate their session at block 870. If it is determined at block 870 not to terminate the session, the agent may then be redirected to again access the landlord dashboard at block 812. If it is determined at block 870 to terminate the session, the operation may end at block 880.

Landlord may also manage staff, favorite vendors, direct hired agents, advertisers, and other support staff and third parties. Landlord can also access CMS and manage aspects of this section which may include purchased numbers, set follow-up reminders for various tasks, auto-responses, newsletters, and other features described for CMS elsewhere in this disclosure. Landlord may manage landlord's profile and available payment option to collect income and pay expenses.

Illustrative renter operations will now be discussed, without limitation. The renter may have several options to start the rental process, including broker assistance via the broker-assisted process and direct interaction with the landlord via the landlord direct process. For the broker-assisted process, that renter may start by accessing the platform, for example via a web-based interface, or starting from a landing page where the renter may register using a form, for example, after being redirected from a call, text, link, barcode, QR code, or search engine. After renter registers and passes the initial criteria, the renter may schedule/reschedule/cancel an appointment with an agent by scheduling time directly on an agent's calendar. This scheduling feature frees up time for the agent and reduces the dependency on a receptionist. If the renter chooses to schedule an appointment and does not show up, then the user will be substantially automatically given a reminder by the system to schedule another appointment to come in or re-engage with the process.

If the renter does come in, the renter may receive appointment reminders, and may also create the profile which includes completing screening information, screening information that may help determine or estimate a cost of a processing and service fee, uploading documents, completing forms and sending verification form and notifications, searching for properties and communicating with an agent and/or landlord directly through the customer's dashboard in their renter dashboard interface. Once a renter attends their appointment, or if the renter elects not to have an appointment, reschedule, or request a call, the renter can pay a processing fee to build a profile and start the service. At substantially any point, the renter can opt out to stop receiving communication. One or more of these operations may be performed using a decentralized autonomous organization, which may include use of smart contracts. Contractual terms, processing fees, and service fees may be changed without limitation and may also be called membership fee/points fees and lease offer fee respectively.

A landlord may substantially immediately have access to suggested listings based on the renter profile created for the renter. From these suggested listings, renter can customize the search and invite any landlord to view their renter profile. Upon receiving the invitation from the renter, the landlord can either register, create temporary access to view the renter's profile, or can log into the landlord's existing account.

From the landlord dashboard, the landlord can view invitations and applications for the rental units that are available now or coming available in the future. If the landlord and renter wish to negotiate and proceed with a lease, the parties can do so substantially instantly through the lease form available to them online. Prior to lease, the renter and landlord may have the option of supplying their viewing experience/rating/reviews and negotiating lease terms virtually. Throughout the entire process, an agent may be available to help the transaction.

If the landlord would like additional security as a condition of signing a lease, or if the renter wants to have an advantage over rival renter applicants, or if the landlord requires the use of GRIP, then the renter and/or landlord have the option of purchasing a GRIP plan by having the renter and/or landlord pay to protect and secure the landlord against lease default. Once any applicable upfront fees are paid and monthly payment schedules are set, the renter and the landlord may complete the lease and join the renter community. If a landlord is approved to receive GRIP, this may also be a statement of security for a prospective renter as not every landlord is eligible for GRIP. GRIP may provide a measure of exclusivity and network access that is attractive to renter consumers and landlords and can be used to market to those groups. Landlords may pay some or no fee to advertise their score, rating, GRIP level, GRIP credentialing, or other details on a monthly, annual, or other recurring basis. GRIP qualification may be synonymous with the SSL trust seal. If a landlord or renter has 5-star rating and GRIP, then consumer is the most sought after and trusted member, eligible to the best of benefits, deals, discounts, and awards. 5-star GRIP members may have synonymous membership levels like, “Diamond Member,” and may be eligible to receive exclusive offers. At least part of this information may be included in a distributed ledger.

Information gathered from the start of the process until the lease is signed may be used to build the renter profile and established the renter score, which may be further developed while the renter is using the renter community. At least part of this information may be included in a distributed ledger. In the renter community, the renter may be communicating with other renters, landlords, maintenance people, vendors, paying rent online, and engaging in commerce. These activities may help build the renter score.

The renter can also start the landlord direct process by searching for apartments on the interface. Once a renter finds a rental listing, the renter may apply directly through the listing. The renter may communicate with the landlord via the communication component, schedule viewings, complete and send rental applications, rate viewing experience, upload photos of the unit to be viewable and rated by the community, landlord, property and unit, negotiating the lease, and joining the renter community, all of which may be done remotely and substantially automatically, for example, as administered by a decentralized autonomous organization. A GRIP plan may be offered, as discussed above. The renter may also be provided access to the renter community, also as discussed above.

Referring now to flowchart 900 of FIG. 9, an illustrative method for a renter operation will be described, without limitation. Starting with block 902, the operation may begin by a renter calling, texting, following a link, scanning a QR code or other link, or otherwise being directed to a page, application, mobile app, online form, or other interface to fill an initial form, for example, a fasttrak form. (Block 903). The operation may then continue with the renter filling a form, such as a digital form provided online, through a mobile app, or otherwise. (Block 904). Once the form is at least partially filled, the operation may determine if the renter qualifies for assistance through an aspect of a system enabled by this disclosure. (Block 906). If it is determined at block 906 that the renter does not qualify for assistance, the renter may be provided an option to retry filing out the form. (Block 908). This may be useful if the renter omitted important information or made a mistake on the form. Additionally, the unqualified renter may end their operation with the system at block 908. If it is determined at block 906 that the renter qualifies for assistance, the operation may continue with the renter searching for properties or otherwise accessing the system. (Block 910). The renter may be directed to their renter dashboard.

The renter may then choose a feature to interact with the system. (Block 920). If it is determined at block 920 that the renter desires to perform managing operations, the renter may be directed to manage information in their renter profile and manage information in screening, documents, e-forms, an application, and/or record video. (Block 922). The renter may additionally manage their appointments and viewings. (Block 924). Furthermore, renter may manage authorization tokens, selecting whether to grant, restrict, or revoke associated rights. (Block 926). At the time the renter creates a profile, they may choose if they wish to be contacted by a landlord or agent and decide which profile may be visible to which type of user.

If it is determined at block 920 that the renter desires to perform search operations, the renter may be directed to optionally create a renter profile and/or login account. (Block 930). The renter may also manage co-applicants and related relationships, as discussed throughout this disclosure. The renter may be provided search features to locate available units, which may optionally be refined by the renter. (Block 932). In at least one embodiment, a renter may also choose to invite/connect with other renter(s), tenant(s), or other members of the community to rent the same real property unit by searching for renters that may be mutually compatible according to, without limitation, age, sex, income, occupants, pets, disability, and other factors that would be appreciated by a person of skill in the art after having the benefit of this disclosure. This feature may advantageously help renters and/or tenants connect and share the costs and rents associated with a rental unit, create a sublease, or otherwise help coordinate the rental relationship between parties.

It may then be determined whether the renter has a renter profile. (Block 940). If it is determined at block 940 that the renter is not associated with a renter profile, the renter may be provided an option to create a renter profile. (Block 941). If it is determined at block 940 that the renter is associated with a renter profile, or at block 941 that the renter created a renter profile, the renter may be provided with an option to mark and view search history and/or favorites and/or invite landlords to see at least some of the renter profile. (Block 942). The renter may be provided an option to apply for a transactional relationship for a real property unit substantially directly to a landlord or assisted by a broker, for example, by submitting a lease application and paying to secure the landlord's offer to lease. (Block 944). The renter may also be provided an option to communicate with landlords, broker/agent, and/or the community. (Block 946). The operations of blocks 944 and 946 may include negotiation and signing of a lease. The renter may additionally be provided access to the tenant dashboard. (Block 948). Access to the tenant dashboard may be at least partially restricted if the renter has not yet transitioned to become a tenant.

From block 926 or 950, or if block 941 was decided in the negative, the renter may then determine whether to terminate their session at block 950. If it is determined at block 950 not to terminate the session, the renter may then be redirected to again access the renter dashboard and system at block 910. If it is determined at block 950 to terminate the session, the operation may end at block 960.

In one example, once the renter fills out and submits an initial “FastTrack form”, which may include their name/phone number, the FastTrack form may create a renter's account and then may match renters to units renters may qualify for through using auto-criteria matching. After the renter completes the FastTrack and has their account, the renter may have access to schedule appointments, upload documents, fill out forms, which may include a “no agency” form as may be permitted by law, create their profile, and get substantially instantly matched to properties before they meet with the agent. If the renter desires, the renter may schedule/reschedule/cancel their own appointments to meet with an agent when agent shows they are available. Once such an appointment is scheduled by the renter or by an agent for a renter, agents and renters may be sent text, email, account reminders of their appointments, and that renters are informed what amount of money to bring before they come to their appointment. The agent may then assist the renter in locating and selecting a suitable rental unit.

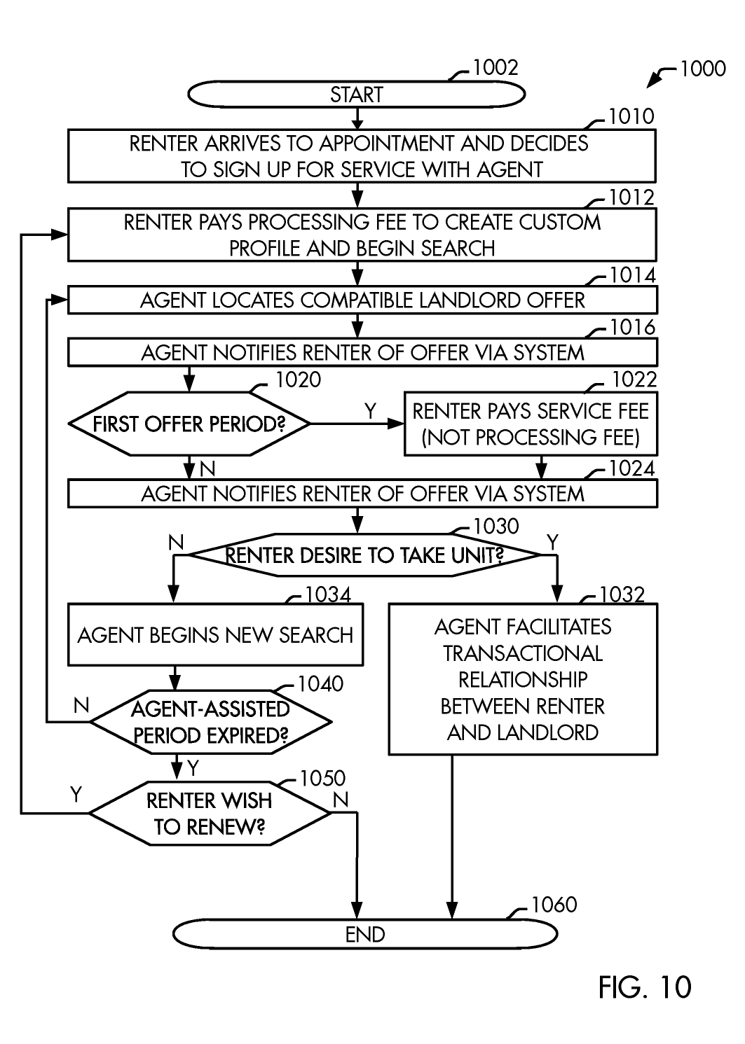

Referring now to flowchart 1000 of FIG. 10, an illustrated method for an agent-assisted renter operation will be described, without limitation. Starting with block 1002, the operation may begin by the renter arriving at an appointment and deciding to sign up for service with an agent. (Block 1010). The renter may then pay a processing fee to create a custom profile and begin a search for a landlord offer to lease a rental unit. (Block 1012). The custom profile may include renter information, for example audio/video recordings, and other details that may assist in finding a landlord offer to lease a rental unit for/by the renter. This information may optionally be included in a distributed ledger. The agent may then locate compatible landlord offers for the renter. (Block 1014). Once the agent locates a compatible landlord offer, the agent may notify the renter using a system provided by this disclosure. (Block 1016).

The operation may then determine if this is the first offer provided to the renter within an agent-assisted period. (Block 1020). If it is determined at block 1020 that this is the first offer in the agent-assisted period, the renter may pay a service fee to access the results. (Block 1022). In this example, the service fee paid at the operation of block 1022 is different than the processing fee paid at the operation of block 1012, with the agent being unable to charge another processing fee at the operation of block 1022. If it is determined at block 1020 that this is not the first offer in the agent-assisted period, the renter may not be required to pay an additional service fee. After the operation of block 1022, or if block 1020 was determined and the negative, the operation may continue to set a meeting for the renter and the landlord at the unit for an interview. (Block 1024). This process advantageously allows a renter and landlord to interview without an agent, allowing agent to save time by avoiding showing an apartment yet secure agent's fee without risk of circumvention.

It may then be determined whether the renter decides to take a landlord offer to lease a rental unit. (Block 1030). If the operation of block 1030 is decided in the affirmative, for example the renter decides to take the rental unit, the agent may facilitate the transactional relationship between the renter and the landlord. (Block 1032). This transactional relationship may include signing of a lease agreement and transitioning the renter to a tenant. The operation may then end at block 1060 with the renter paying the applicable money to landlord/authorized person to secure the lease, if any money is required by the landlord to secure tenancy rights.

If it is determined at block 1030 that the renter does not decide to take a landlord offer to lease a rental unit, the agent may begin a new search. (Block 1034). This new search may be performed, for example, at no extra charge or for a fee if an agent established threshold has been met, allowing the agent to charge. Once the decision to start the new search is made, it may be determined whether the agent-assisted period has expired. (Block 1040). An agent-assisted period may be given a duration, for example 90 days or as law may permit, after which the agent services are no longer provided. In some embodiments, this period may be extended for a fee. If it is determined at block 1040 that the agent-assisted period has not yet expired, the operation may return to block 1014 where the agent may again locate a compatible landlord offer. If it is determined at block 1040 that the agent-assisted period has expired, the operation may continue to block 1050, wherein the renter may decide whether to renew another agent-assisted period. If it is determined at block 1050 that the renter wishes to renew the agent-assisted period, the operation may return to block 1012 where the renter may pay an additional processing or otherwise named fee and create and/or update their profile. A new search may then begin. If it is determined at block 1050 that the renter does not wish to renew the agent-assisted period, the operation may then end a block 1060.

Additional advantages of this disclosure will now be discussed, without limitation. Embodiments enabled by this disclosure advantageously solve prior deficiencies such as providing only a one-directional, landlord-selected-by-renter matching system where property owner receives tenant preferences associated with a desired prospective tenant and associating the tenant preferences with the property owner profile. Such deficient systems only enable interaction between property owners and prospective tenants having a matching score above a predetermined value, excluding interaction between parties that are not scored or that have an insufficient score. The present disclosure advantageously leverages feedback from multiple parties and sources in determining the compatibility between not only a renter and landlord, but also the renter and other considerations relating to a rental unit such as other tenants, block rating, reviews, renter behavior, regulatory restrictions, pets, sex offender status, maintenance request history, engagement with maintenance providers and other vendors, and other relevant information. For the purposes of this paragraph, a “block” may be a street block or several street blocks known to local residents and a “neighborhood” may be designated by a municipality, without limitation. Those of skill in the art will understand the differences between a street block and a block includable by a blockchain, especially after having the benefit of this disclosure. Additionally, embodiments enabled by this disclosure advantageously benefit from information in addition to a score that may be analyzed when determining whether to match a renter with a property unit associated with a landlord. Embodiments advantageously focuses on how compatible a renter is for a prospective landlord and associated rental unit and compatible with building culture, block culture, and neighborhood culture.

Advantages provided by this disclosure as it relates to embodiments using a decentralized cryptographic application will now be discussed, without limitation. Decentralized systems, such as systems including a distributed ledger and/or blockchain advantageously allow digital information to be distributed but not corrupted. Information relating to the decentralized system may be distributed over multiple virtual locations, such as notes, over a distributed network. The network of nodes may validate the information relating to a renter profile, rental unit, landlord, vendor, or other party, facilitate a transaction, and maintain the status of the user using computer-determined algorithms. The nodes may verify the transaction and/or result of analyzing data.

User transactions, such as the distribution of authentication tokens or entering of a lease agreement, may be combined with other transactions to create a block of data, which may be included in the ledger. This block may be added to existing data to form a chain of verified transactions and/or data. This chain of data may be included in a blockchain. The data stored in the blockchain may be cached substantially permanently and may be substantially unalterable.

Once a block is added to the chain, the data in the block may be substantially unalterable, providing the ledger of economic transactions, information, and other data that may be analyzed by other processes and/or to help with extracting predictions, reporting past behavior, and/or modeling future behavior.

The ledger chain data may be distributed to multiple nodes, which may hold the data in a distributed network of nodes. Information held and these chains of data may be reconciled, verified, and otherwise confirmed to be accurate. Storing the data, including data related to actors, tenants, landlords, GRIP, and other aspects of this disclosure, may advantageously be decentralized to promote independence, data mobility, and increase the usefulness of the data.

The inclusion of data and associated transactional information relating to the data by a chain may advantageously allow multiple parties to access and work with the data stored in the block substantially simultaneously. Storing and distributing data in this manner may advantageously reduce the likelihood of inconsistent data on record, inconsistencies and versioning between multiple parties accessing and/or using the data, and substantially simultaneous distribution of changes and modifications to the data such that substantially any party with access to the data may receive an approximately current version of the data. This distributed approach to storing, sharing, and modifying data between multiple parties advantageously improves over the deficiencies in the current state of the art that requires temporarily restricting access to the data, possibilities of multiple parties making simultaneous edits to the data that are not reconciled, and other difficulties inherent to multiple parties attempting to access and/or modify shared sets of data.

A data storage and distribution platform enabled by this disclosure may advantageously enhance the durability and robustness of the data contained within the platform. Since multiple iterations of the data may be distributed across various nodes in the network, a data storage platform from this disclosure may substantially eliminate the likelihood of having a single point of failure. Additionally, the data storage platform provided by this disclosure may advantageously reduce the likelihood of unauthorized alteration, deletion, or corruption of data, since the data cannot be controlled by any single party or affected by any single entry.

Additionally, the data storage and distribution platform of this disclosure advantageously reduces the possibility of a transaction being missed, errors caused by human and machines, exchanges being performed without the consent of the parties involved and ensuring the validity of the transaction by recording that transaction to a register and one or more distributed ledgers across the network of nodes.

The data stored in the chain may be verifiable using a system of checks and consensus. For example, a network of nodes may be configured to substantially automatically request an indication of consistency with the main record in a given interval. For example, the interval may be periodic, dynamic, fixed, variable, or otherwise determined for the application which the blockchain is implemented. This configuration advantageously increases transparency of the data embedded within the network of nodes, as the data may be accessed and verified by practically any node in the network. Additionally, this configuration may advantageously eliminate the possibility of data being corrupted, in part, due to the substantial computational requirement to manipulate data in such a way that may override the entire network of nodes. In this way, the distribution of data across the nodes substantially eliminates the risk of data manipulation by an undesired party, as no centralized party can corrupt the data.

In the distributed network of nodes, each node may be configured as an administrator of the blockchain. These nodes may include the computers of renters, agents, landlords, vendors, or other parties to the system. The nodes may additionally include third parties providing their processing power in exchange for an incentive, such as a virtual currency. The nodes may join the distributed ledger, which may be provided by the blockchain, voluntarily, advantageously promoting the decentralization of the network. In one embodiment, the supplier of each node may be incentivized to join the network. For example, a virtual currency may be offered to the operator of the node in exchange for the computational power provided by the node. This process could be called mining, and the party providing the computational power may be called a miner. This virtual currency may be provided as a cryptocurrency, a credit to an account, a refund of payments made, a discount, or another monetized incentive that would be appreciated by persons of skill in the art after having the benefit of this disclosure. In another embodiment, operators of the node may be incentivized to provide computational power by creation of virtual rewards such as badges, experience points, levels, digital content, other elements of gamification, or other incentives that would be appreciated by persons of skill in the art after having the benefit of this disclosure.

In an example of a decentralized cryptographic platform for real estate transaction assistance enabled by this disclosure, the blockchain may include data relating to renters, tenants, landlords, owners, buyers, sellers, agents, brokers, and other parties related to a real estate transaction. The blockchain may additionally include information related to rental units, apartments, condominiums, houses, commercial real estate, and other properties that may be bought, sold, rented, leased, or otherwise possessed by a party. Additional information may be associated with the above-mentioned data, such as performance history of a renter and/or tenant, repair requests associated with the unit, complaints made about a renter and/or tenant, complaints filed by the renter and/or tenant, payment history, financial information, likelihood of timely payment, responsibility, and other information that may assist in the determination of offering possession of a residence, commercial establishment, or other location. In this example, entry into record into the blockchain may advantageously be distributed an updated substantially simultaneously with other parties having access to the blockchain. Due to the decentralized nature and robustness of the blockchain, a party may not be able to alter this record simply because they do not agree with the information in record.

The application data may be associated with many points of a real estate transaction and may additionally assist in detecting patterns relative to those points. For example, information about a renter entered into the blockchain may be indicative of timely payment, but the renter may have a history of filing complaints about other tenants. This record may indicate that while this renter is likely to pay on time, they may create great difficulty for a landlord in the amount of management required to deal with their personality. In another example, the record may indicate that although during a localized time the tenant was not able to make on-time payments but has since achieved financial stability such that the likelihood of timely payments has drastically increased. In this example, the information included in the blockchain may be substantially more beneficial to a perspective landlord than merely a credit score that lacks the fine details of a record included in the chain.

The decentralize cryptographic real estate transaction assistance platform enabled by this disclosure may advantageously include smart contracts. For example, smart contracts may include distributed features with defined conditions, which once met, can trigger at least partial execution of the contract. For example, a lease agreement may be created as a contract between a landlord and a renter as a smart contract. This smart contract lease may be set to execute upon parties verifying information about themselves, such as providing proof of income, and agreeing to the terms discussed between the parties or the lease may execute upon payment of a move-in fee. The smart contract may additionally include the condition that upon execution of the contract, an agent assisting the transaction is compensated for their time and effort and landlord's mortgage is paid.

In another example, for a real estate property with an investor, a percentage may be paid to the investor when a threshold amount of income is received for the investment property. Skilled artisans will appreciate that these examples are provided merely to illustrate possible scenarios in which a smart contract is included in the decentralize cryptographic estate transaction assistance network and are not intended to limit the functionality or scope of this platform in any way.

In another example of a smart contract, a lease engaged between a landlord and tenant may include a condition that upon availability of funds in the tenant's account and a specified date, such as the first of the month, the funds are substantially automatically withdrawn from a register associated with the tenant and transferred to a register account associated with a landlord. In this example, money or another value may be transferred between multiple parties.

The smart contract in this example may additionally be expanded including the condition of possession of the property. For example, the smart contract may also include the duration of the lease term such that rental payments are transferred between the parties as long as the lease is in effect, however possession to the unit may be legally withdrawn upon conclusion of the term. Not only will the smart contracts in this example make such transactions easier, they also speed up the rate at which a transaction may occur while reducing the likelihood of any errors occurring through such a transaction to be negligible if at all. Smart contracts associated with this disclosure may not only define rules, penalties, and distribution of resources between parties, but such smart contracts may automatically enforce these aspects.

In an additional embodiment, files relating to properties, parties, and financial transactions may be decentralized using a platform enabled by this disclosure. Decentralization of these files may advantageously reduce the likelihood of such a file getting lost, corrected, or manipulated without authorization. The files may be encrypted such to only allow access to the contents of such files to the intended parties. However, various copies of the files may be distributed to multiple nodes ensuring that data loss is highly unlikely.

In one embodiment, a virtual coin may be used for tracking, monetizing, and rewarding positive social behavior and internal commerce. For example, every time a 5-star review or rating is received by a member of the community, that member may receive a virtual coin to purchase goods, service, apply as credit against rent, partner debt, and security instruments. When a virtual coin holder withdraws money from the community, the member may be subject to capital gains. Members may also convert other currency and cryptocurrency to/from the virtual currency associated with a platform enabled by this disclosure. Virtual coins may appreciate, for example, the longer the member holds the coin, the fewer coins there are, and the more those virtual coins are worth. Members may also mine to earn coins, providing computational power to operate the system in the process or by allowing the system to use computation power of the miner's personal computers encrypting and decrypting for the community.

In one embodiment, a decentralized system may be based using an Ethereum blockchain or similar cryptographic technology. Ethereum blockchain or similar cryptographic technology may be used to track transactions and use smart contracts to manage lease agreements, payment and delivery terms, and conditions which may recognize lease defaults, rent discounts and incentives, accounting of money with built-in mechanisms to transfer some or all money to payment revenue or payment accounts. Use consensus and blockchain may be used to validate/authenticate user reviews and ratings and for other purposes, without limitation. User review may include, but are not limited to/from/between, renters, agents, landlords, contractors, businesses, products, services, tenants, employees.

Embodiments enabled by this disclosure may leverage distributed ledgers, decentralization, blockchain, and/or similar technologies, as well as cryptocurrency to implement in the data and assumptions used to calculate and issue Guaranteed Rental Income Protection (GRIP) insurance. GRIP may be used in combination with blockchain and similar technology, as well as cryptocurrency may be used in calculation and issuance of new financial instruments such as backing consumer loans, commercial loans, other types of loans, notes, liens, or lines of credit, consumer and business credit, debt instruments, securities, and for use in trade, secondary markets and any electronic registry. Same may be applied to use in real estate buy/sell transactions as renters transition to becoming homebuyers, car buyers, etc.

As discussed above, embodiments enabled by this disclosure may use/create a decentralized autonomous organization (DAO) in agent hierarchies, which may grow to be larger than the brokerage office the agent works for. The Agent DAO may use smart contracts to pay/receive compensation for goods/services. DAO may be used to create permanent transaction teams where agents can maintain collaborative teams that may be local or virtual, and receive fractional compensation based on the effort those agents contribute. The decentralized autonomous organization may be used to establish at least part of a platform that allows renters, agents, and landlords to interact seamlessly, in a decentralized way, with ledgers and smart contracts; building relationships and participating in transactions where information, services, and ownership of assets, can be assigned or transferred using tokens and currency all without an intermediate third-party to monitor and charge fees to transactions. Elimination of third-party fees may reduce time and cost, allow data transfers and transactions to be fast, simple, and low cost. Participants may withdraw money from the system at some point in the future if they choose to use this digital currency for traditional purchases in a market outside of the ecosystem of this disclosure.

In one embodiment, the broker-assisted process may be at least partially operated by a DAO, advantageously expanding operation beyond the model of brokerage silos like currently used in the present art by allowing agents to create agreements through using smart contracts and local and virtual agent hierarchy. These hierarchies may allow agents to occupy one or more roles, including a lead generator that may earn passive income by offering/selling leads to the lead pool where H.I.M. agents can purchase. Additional roles may include a Hive team that may work in a tight hierarchy, an Individual that may work in a loose hierarchy or independent, a Mentor that may work in a teaching/mentorship capacity by on-boarding and training new agents, and other roles that would be appreciated by a person of skill in the art after having the benefit of this disclosure.

A system enabled by this disclosure may advantageously include noteworthy distinctions to how agents may operate or function over the deficiencies this invention seeks to solve. First, many or substantially all subscriber agents may work in a corporate-like environment performing a substantial number of functions in an office since our system allows agents to earn income without doing showings. Second, a database leveraged broker-assisted process enabled by this disclosure may also allow agents to earn an income regardless if the transaction closes in a lease transaction. Third, agents using a system enabled by this disclosure can also earn more money without splitting commission, as is common for agents who use the multiple listing system (MSL), because with a system enabled by this disclosure may not require use of the MLS as subscribers have access to a landlord database.

Crowdfunding may additionally be facilitated by this disclosure. Decentralized systems and methods enabled by this disclosure allow parties to purchase and hold the virtual currency and work collaboratively to purchase large products in a substantially safe, secure, and decentralized way such as for the use in buying groups and crowdfunding and use smart contracts to accumulate, distribute funds, execute contracts, and perform other operations that would be appreciated by a person of skill in the art after having the benefit of this disclosure.

Data security may additionally be improved in embodiments enabled by this disclosure. Currently, data is generally not secure without cryptography. Due to prevalent hacking by private and state actors of private and public systems, achievement of stable data security is becoming a practically impossible feat. Data accuracy and reliability is in question without blockchain or similar technology. Platforms based on this disclosure will advantageously be the first to create a real-life application in the real estate field for the DAO, blockchain, Ethereum, smart contracts, and/or consensus-based models.

In one embodiment, renters may provide information to a system enabled by this disclosure through at least information provided through a survey. For example, a survey may be distributed to renters highlighting the differences between a system enabled by this disclosure and traditional rental systems. The survey may include questions relating to service costs, search costs, credit consideration, alternative credit qualification techniques, approval process, survey completion, and/or renter selection of services to be provided. The survey may additionally include features regarding a fast track process of criteria matching and use of a system enabled by this disclosure, processing fees, proposed sequence of events, techniques for locating an appropriately-priced lease offer, information regarding interviewing with a landlord, information regarding sharing at least part of the information included in a renter profile, a list of frequently asked questions, and other information. The survey may require the signature of a renter or other party to enable use of the supplied information, which may be provided physically, electronically, or otherwise. In embodiments including decentralization, at least part of the information provided in the survey or the survey itself may be included by a distributed ledger. For example, the survey information may be provided in a block that may be included by a blockchain. At least part of this information may be provided to the distributed ledger via an oracle. Smart contracts may be used to allocate funds relating to services performed by an agent and determine, assign, control, act on terms, conditions, payment, refund, credit for services, and/or perform other functions.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A system for assisting a transaction comprising:
a database accessible via a network to store and communicate data relating to a transactional relationship and rules applied to the transactional relationship, the database being decentralized;
platform components communicably connected to the database to analyze and manipulate the data, the platform components comprising:
a renter component to manage a renter profile comprising renter information and analyze at least part of the renter profile to derive a renter score for association with a renter, the renter score being includable by the renter profile, and the renter profile being included by the database,
a renter profile validation aspect to validate at least part of the renter information, the renter information determined not to be valid being selectively excluded from the renter profile,
a matching component to compare at least part of the renter profile and information indicative of renter behavior to the rules to determine whether a likelihood of compatibility with a landlord requirement relative to a real property unit meets a matching threshold, and matching the renter and a landlord meeting the matching threshold,
a token exchange aspect to coordinate sharing of at least part of the renter profile at least partially identifying the renter with the landlord, the renter granting access to an authorization token for the landlord of the real property unit for consideration for the transactional relationship, and wherein the authorization token is revocable, and
a communication component to facilitate interactions and organize the interactions, the interactions being recordable to the database; and
an interface accessible to interact with the data and at least one of the platform components;
wherein at least part of the data is analyzed to predict a behavior associated with the transactional relationship and/or parties to the transactional relationship.

2. The system of claim 1, wherein the platform components are at least partially operable as a decentralized autonomous organization.

3. The system of claim 1, further comprising:
a smart contract component to define at least part of the rules and execute an action of a smart contract upon compliance with a condition of the rules; and
wherein the rules comprise determining the likelihood of compatibility between the parties to the transactional relationship.

4. The system of claim 3, further comprising:
a broker-assisted component to assist an agent with the transactional relationship comprising:
an agent-renter CRM aspect to at least partially automate tasks related to the transactional relationship using the smart contract, and
a renter qualification aspect that works with the matching component to substantially identify the renter with the likelihood of compatibility with the landlord for the real property unit in consideration for the transactional relationship.

5. The system of claim 1, wherein the database is at least partially provided as a distributed ledger, and wherein the data added to the database is added to the distributed ledger.

6. The system of claim 1, further comprising:
a guaranteed rental income protection to assure financial stability in the transactional relationship;
wherein the rules comprise a threshold of eligibility for the guaranteed rental income protection;
wherein the guaranteed rental income protection is selectively offered for the transactional relationship that meets the threshold of eligibility; and
wherein the guaranteed rental income protection is marketable as a financial instrument.

7. The system of claim 1, wherein the database is provided as a blockchain to store the data, wherein the data being added or manipulated is added as at least part of a block to the blockchain, and wherein historical transactions associated with the data is accessible from the blockchain.

8. The system of claim 7, further comprising:
a guaranteed rental income protection to assure financial stability in the transactional relationship;
wherein the rules comprise a threshold of eligibility for the guaranteed rental income protection;
wherein the guaranteed rental income protection is selectively offered for the transactional relationship that meets the threshold of eligibility;
wherein the guaranteed rental income protection is reflective of at least part of the data stored in the blockchain; and
wherein the guaranteed rental income protection is stored in the blockchain.

9. The system of claim 1, wherein the platform components further comprise a landlord direct component comprising:
a renter search aspect to locate the renter prospective to engage in the transactional relationship, the renter being filterable by the renter score;
wherein the landlord direct component communicates with the matching component to connect the renter having the likelihood of compatibility that is acceptable with the landlord; and
wherein the information relating to the renter having the likelihood of compatibility that is acceptable with the landlord is storable in the database.

10. The system of claim 9, wherein the landlord direct component further comprises:
a record keeping aspect to log at least part of the interactions between the parties, the at least part of the interactions being storable in the database; and
a renter community aspect to facilitate the interaction between at least the renter, additional renters, and the landlord, the interactions being storable in the database.

11. The system of claim 1, wherein the platform components further comprise a landlord management component comprising:
a landlord financial aspect to receive payments from the renter; and
a maintenance request aspect to receive a maintenance request for the real property unit;
a landlord-vendor management aspect to request service from a vendor, manage costs to the vendor, and log the interactions with the vendor; and
a tenant exchange to transact rights to a tenant of the transactional relationship.

12. A system for assisting a transaction comprising:
a database decentralized among a distributed ledger and accessible via a network to store and communicate data relating to a transactional relationship and rules applied to the transactional relationship;
platform components at least partially operable as a decentralized autonomous organization communicably connected to the database to analyze and manipulate the data, the platform components comprising:
a renter component to manage a renter profile comprising renter information and analyze at least part of the renter profile to derive a renter score for association with a renter, the renter score being includable by the renter profile, and the renter profile being included by the database,
a matching component to compare at least part of the renter profile and information indicative of renter behavior to the rules to determine whether a likelihood of compatibility with a landlord requirement relative to a real property unit meets a matching threshold, and matching the renter and a landlord for which the matching threshold is met,
a token exchange aspect to coordinate sharing of at least part of the renter profile at least partially identifying the renter with the landlord, the renter granting access to an authorization token for the landlord of the real property unit for consideration for the transactional relationship, and wherein the authorization token is revocable,
a smart contract component to define at least part of the rules and execute an action of a smart contract upon compliance with a condition of the rules, and
a communication component to facilitate interactions and organize the interactions, the interactions being recordable to the database; and
wherein at least part of the data is analyzed to predict a behavior associated with the transactional relationship and/or a party to the transactional relationship.

13. The system of claim 12, further comprising:
a renter profile validation aspect to validate at least part of the renter information included by the renter profile, the renter information determined not to be valid being selectively excluded from the renter profile; and
an interface accessible to interact with the data and at least one of the platform components.

14. The system of claim 12, further comprising:
a broker-assisted component to assist an agent with the transactional relationship comprising:
an agent-renter CRM aspect to at least partially automate tasks related to the transactional relationship using the smart contract, and
a renter qualification aspect that works with the matching component to substantially identify the renter with the likelihood of compatibility for the landlord for the real property unit in consideration for the transactional relationship.

15. The system of claim 12, further comprising:
a guaranteed rental income protection to assure financial stability in the transactional relationship;
wherein the rules comprise a threshold of eligibility for the guaranteed rental income protection;
wherein the guaranteed rental income protection is selectively offered for the transactional relationship that meets the threshold of eligibility;
wherein the guaranteed rental income protection is reflective of at least part of the data stored in the distributed ledger; and
wherein the guaranteed rental income protection is stored in the distributed ledger.

16. The system of claim 12, wherein the distributed ledger is provided as a blockchain to store the data, wherein the data being added or manipulated is added as a block to the blockchain, and wherein historical transactions associated with the data is accessible from the blockchain.

17. The system of claim 12, wherein the platform components further comprise:
a landlord direct component comprising:
a renter search aspect to locate the renter prospective to engage in the transactional relationship,
a record keeping aspect to log at least part of communications between parties, the at least part of the communications being storable in the database,
a renter community aspect to facilitate the interaction between at least the renter, additional renters, and the landlord, the interactions being storable in the database, and
wherein the landlord direct component communicates with the matching component to connect the renter having an acceptable likelihood of compatibility with the landlord, the information relating to the renter having the acceptable likelihood of compatibility being storable in the database; and
a landlord management component comprising:
a landlord financial aspect to receive payments from the renter,
a maintenance request aspect to receive a maintenance request for the real property unit,
a landlord-vendor management aspect to request service from a vendor, manage costs to the vendor, and log the interactions with the vendor, and
a tenant exchange to transact rights to a tenant of the transactional relationship.

18. A method of facilitating a transaction via a cryptographic system comprising:
(a) communicating data and rules stored in a database decentralized among a distributed ledger and accessible via a network by platform components, the data relating to a transactional relationship, and the rules being at least for determining a likelihood of compatibility between parties to the transactional relationship;
(b) managing a renter profile comprising renter information by a renter component and analyzing at least part of the renter profile to derive a renter score for association with the renter, the renter score being includable by the renter profile, and the renter profile being includable by the database;
(c) comparing at least part of the renter profile and information indicative of renter behavior to the rules by a matching component to determine whether the likelihood of compatibility with a landlord requirement relative to a real property unit meets a matching threshold;
(d) matching the parties for which the matching threshold is met; and
(e) selectively assuring financial stability in the transactional relationship via a guaranteed rental income protection;
wherein the rules comprise a threshold of eligibility for the guaranteed rental income protection;
wherein the guaranteed rental income protection is selectively offered for the transactional relationship that meets the threshold of eligibility;
wherein the system comprises a token exchange aspect to coordinate sharing of at least part of the renter profile at least partially identifying the renter with the landlord, the renter granting access to an authorization token for the landlord of the real property unit for consideration for the transactional relationship, and wherein the authorization token is revocable; and
wherein the system comprises an interface accessible to interact with the data and at least one of the platform components.

19. The method of claim 18, further comprising:
(f) assisting an agent with the transactional relationship by a broker-assisted component, further comprising:
(i) at least partially automating tasks related to the transactional relationship using a smart contract,
(ii) operating with the matching component to substantially identify the renter with the likelihood of compatibility for the landlord with the real property unit in consideration for the transactional relationship, and
(iii) coordinating sharing of at least part of the renter profile from the renter to the landlord via the token exchange aspect.

20. The method of claim 18, further comprising:
(g) assisting the landlord with the transactional relationship by a landlord direct component comprising:
(i) locating the renter prospective to engage in the transactional relationship relative to the real property unit, the renter being filterable by the renter score,
(ii) communicating with the matching component to connect the renter having an acceptable likelihood of compatibility with the landlord, and
(iii) coordinating sharing of at least part of the renter profile from the renter to the landlord via the token exchange aspect; and
wherein the system comprises a landlord management component comprising:
a landlord financial aspect to receive payments from the renter, and
a maintenance request aspect to receive a maintenance request for the real property unit.
